(19) United States
(12) Patent Application Publication
(10) Pub. No.: US 2022/0405996 A1
(43) Pub. Date: Dec. 22, 2022

(54) PROGRAM, INFORMATION PROCESSING APPARATUS, AND INFORMATION PROCESSING METHOD

(71) Applicant: GREE, Inc., Tokyo (JP)

(72) Inventors: Akihiko SHIRAI, Kanagawa (JP); Takuma KATO, Tokyo (JP)

(73) Assignee: GREE, Inc., Tokyo (JP)

(21) Appl. No.: 17/839,498

(22) Filed: Jun. 14, 2022

(30) Foreign Application Priority Data
Jun. 17, 2021 (JP) 2021-100774

(51) Int. Cl. G06T 13/40; G02B 27/01; H04N 21/81; H04N 21/4788; H04N 21/218

(52) U.S. Cl. CPC G06T 13/40; G02B 27/017; H04N 21/816; H04N 21/4788; H04N 21/8146; H04N 21/21805

(57) ABSTRACT

A non-transitory computer readable medium storing computer executable instructions which, when executed by one or more computers, cause the one or more computers to acquire a mode of a plurality of modes in which each mode corresponding to a line of sight directed to a different object of plural objects, the mode related to a line of sight of an avatar corresponding to a motion of a delivering user wearing a head-mounted display; create, according to the mode, moving-image display data for displaying a moving image of a virtual space in which the avatar is disposed as viewed from a virtual camera; and transmit the moving-image display data to a viewing user device for display to a viewing user.

### CROSS-REFERENCE TO RELATED APPLICATION

This application claims priority to JP 2021-100774, filed in Japan on Jun. 17, 2021, the contents of which is hereby incorporated by reference in its entirety.

### BACKGROUND

Conventionally, there are moving-image delivery systems for producing animated avatars based on motions of users and for delivering moving images containing the animated avatars. Most of the above moving-image delivery systems deliver moving images in which distributors use a multi-functional telephone terminal to deliver moving images. The delivery of moving images using a multi-functional telephone terminal allows expression using avatars of users.

### SUMMARY

In an exemplary implementation of the present disclosure, a non-transitory computer readable medium storing computer executable instructions which, when executed by one or more computers, cause the one or more computers to acquire a mode of a plurality of modes in which each mode corresponding to a line of sight directed to a different object of plural objects, the mode related to a line of sight of an avatar corresponding to a motion of a delivering user wearing a head-mounted display; create, according to the mode, moving-image display data for displaying a moving image of a virtual space in which the avatar is disposed as viewed from a virtual camera; and transmit the moving-image display data to a viewing user device for display to a viewing user.

### BRIEF DESCRIPTION OF THE DRAWINGS

FIG. 1 is a schematic diagram of a system including an information processing apparatus and a server.

FIG. 2 is a diagram illustrating an example of the data structure of user management data.

FIG. 3 is a schematic diagram of a user device.

FIG. 4 is a diagram illustrating the coordinate system of a virtual space and the positional relationship between an avatar and a virtual camera.

FIG. 5 is a diagram illustrating the moving direction of the pupils of the avatar.

FIG. 6 is a schematic diagram illustrating examples of the state of delivering users during delivery of moving images and screens viewed by viewing users.

FIG. 7 is a diagram illustrating the positions of virtual cameras in collaboration delivery in which a plurality of avatars acts together.

FIG. 8 is a diagram illustrating the viewing angle of a virtual camera.

FIG. 9 is a diagram illustrating displaying preview screens that delivering users view during delivering of moving images.

FIG. 10 is a diagram illustrating a first mode in accordance with the present disclosure.

FIG. 11 is a diagram of a screen displayed on a viewing user device during delivery in the first mode.

FIG. 12 is a diagram illustrating a second mode in accordance with the present disclosure.

FIG. 13 is a diagram of a screen displayed on a viewing user device during delivery in the second mode.

FIG. 14 is a diagram illustrating a third mode in accordance with the present disclosure.

FIG. 15 is a diagram illustrating an example of a delivery list screen displayed on a viewing user device.

FIG. 16 is a diagram illustrating an example of a viewing screen including gift objects.

FIG. 17 is a diagram illustrating an example of a viewing screen including messages.

FIG. 18 is a sequence chart of a procedure for delivering moving images.

### DETAILED DESCRIPTION OF THE DRAWINGS

The inventors of the present disclosure have discovered that increasing or broadening a range of expressions of avatars, including facial expressions, by using a head-mounted display may provide a more immersive experience for users and may increase the user satisfaction. The inventors have developed the technology of the present disclosure to address this issue, and the technology of the present disclosure may increase a number of users who view moving images and the number of views, in addition to the number of delivering users and the number of moving images delivered.

In accordance with the present disclosure, a program that solves the above issue causes one or a plurality of computers to function as: a mode acquisition unit that acquires one of a plurality of modes in which a line of sight of an avatar corresponding to a motion of a delivering user who wears a non-transmissive or transmissive head-mounted display is directed to different objects; a moving-image creating unit that creates, according to a specified one of the modes, moving-image data on a virtual space in which the avatar is disposed, the virtual space being photographed by a virtual camera; and a moving-image-data transmitting unit that transmits the created moving-image data to a viewing user device that a viewing user who views the moving image uses.

In accordance with the present disclosure, an information processing apparatus that solves the above issue includes a mode acquisition unit that acquires one of a plurality of modes related to a line of sight of an avatar corresponding to a motion of a delivering user who wears a non-transmissive or transmissive head-mounted display, the modes being such that the line of sight is directed to different objects, a moving-image creating unit that creates, according to a specified one of the modes, moving-image data on a virtual space in which the avatar is disposed, the virtual space being photographed by a virtual camera, and a moving-image-data transmitting unit that transmits the created moving-image data to a viewing user device that a viewing user who views the moving image uses.

In accordance with the present disclosure, a moving-image delivery method that solves the above issue is executed by one or a plurality of computers and includes the steps of acquiring one of a plurality of modes related to a line of sight of an avatar corresponding to a motion of a delivering user who wears a non-transmissive or transmissive head-mounted display, the modes being such that the line of sight is directed to different objects, creating, according to a specified one of the modes, moving-image data on a virtual space in which the avatar is disposed, the virtual space being photographed by a virtual camera, and transmitting the created moving-image data to a viewing user device that a viewing user who views the moving image uses.

In accordance with the present disclosure, a program that solves the above issue causes one or a plurality of computers to function as a line-of-sight-data receiving unit that receives, from a server, line-of-sight data corresponding to a specified one of a plurality of modes related to a line of sight of an avatar corresponding to a motion of a delivering user who wears a non-transmissive or transmissive head-mounted display, the modes being such that the line of sight is directed to different objects, and tracking data indicating the motion of the delivering user, and a display control unit that creates moving-image data on a virtual space in which the avatar is disposed as viewed from a virtual camera using the tracking data and the line-of-sight data and that outputs the moving-image data to a display that a viewing user views.

In accordance with the present disclosure, an information processing method that solves the above issue is executed by one or a plurality of computers and includes the steps of receiving, from a server, line-of-sight data corresponding to a specified one of a plurality of modes related to a line of sight of an avatar corresponding to a motion of a delivering user who wears a non-transmissive or transmissive head-mounted display, the modes being such that the line of sight is directed to different objects, and tracking data indicating the motion of the delivering user, and creating moving-image data on a virtual space in which the avatar is disposed as viewed from a virtual camera using the tracking data and the line-of-sight data and outputting the moving-image data to a display that a viewing user views.

In accordance with the present disclosure, a program that solves the above issue causes one or a plurality of computers to function as a mode acquisition unit that acquires one of a plurality of modes related to a line of sight of an avatar corresponding to a motion of a delivering user who wears a non-transmissive or transmissive head-mounted display, the modes being such that the line of sight is directed to different objects, a creation unit that creates, according to a specified one of the modes, moving-image data for displaying a moving image of a virtual space in which the avatar is disposed as viewed from a virtual camera, and a moving-image-data transmitting unit that transmits the moving-image data in encoded form to a viewing user device that a viewing user who views the moving images uses.

In accordance with the present disclosure, an information processing apparatus that solves the above issue includes a mode acquisition unit that acquires one of a plurality of modes related to a line of sight of an avatar corresponding to a motion of a delivering user who wears a non-transmissive or transmissive head-mounted display, the modes being such that the line of sight is directed to different objects, a creation unit that creates, according to a specified one of the modes, moving-image data for displaying a moving image of a virtual space in which the avatar is disposed as viewed from a virtual camera, and a moving-image-data transmitting unit that transmits the moving-image data in encoded form to a viewing user device that a viewing user who views the moving images uses.

In accordance with the present disclosure, an information processing method that solves the above issue is executed by one or a plurality of computers and includes the steps of acquiring one of a plurality of modes related to a line of sight of an avatar corresponding to a motion of a delivering user who wears a non-transmissive or transmissive head-mounted display, the modes being such that the line of sight is directed to different objects, creating, according to a specified one of the modes, moving-image data for displaying a moving image of a virtual space in which the avatar is disposed as viewed from a virtual camera, and transmitting the moving-image data in encoded form to a viewing user device that a viewing user who views the moving images uses.

In accordance with the present disclosure, moving images that further increase user satisfaction may be delivered.

A management system, which is a moving-image delivery system, according to the present disclosure will be described hereinbelow with reference to the drawings.

Management System

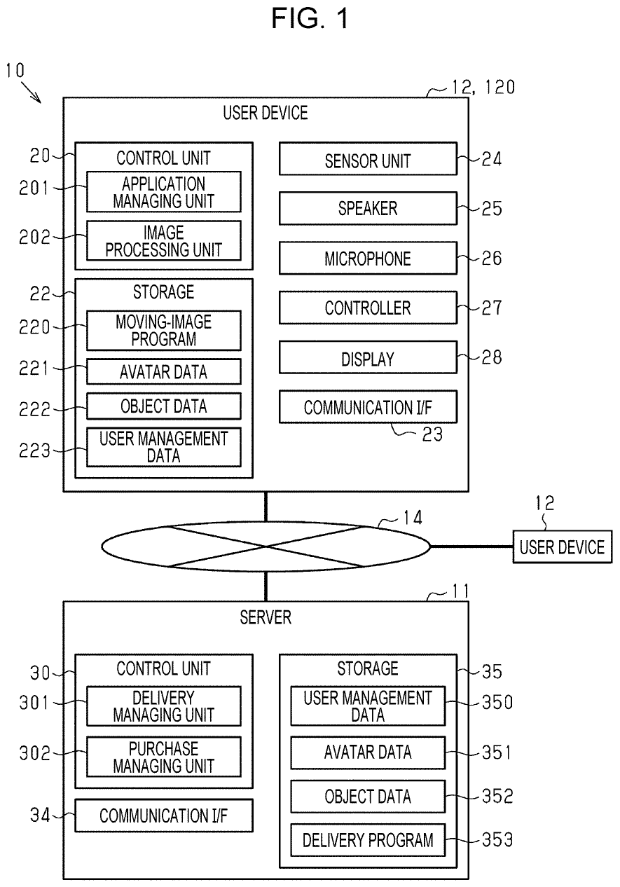

As shown in FIG. 1, a management system 10 includes a server 11 and user devices 12. The management system 10 is a system that displays a moving image delivered by one user to a user device 12 that another user uses by transmitting and receiving data between the server 11 and the plurality of user devices 12 via a network 14 including a cloud server group.

Method for Delivering Moving Image

Moving-image delivery schemes that can be used include a first delivery scheme, a second delivery scheme, and a third delivery scheme. The user devices 12 are capable of operating in both a viewing mode and a delivery mode. A user who delivers a moving image with the user device 12 is referred to as “delivering user”. A user who views the moving image with the user device 12 is referred to as “viewing user”. In other words, a user can be both a delivering user and a viewing user.

The first delivery scheme is a video delivery scheme in which the user device 12 of a delivering user creates moving-image data, encodes the created moving-image data, and transmits it to the user device 12 of a viewing user. The second delivery scheme is a client rendering scheme in which the user device 12 of a delivering user and the user device 12 of a viewing user receive data necessary for creating a moving image to create the moving image. The third delivery scheme is a server video delivery scheme in which the server 11 collects data necessary for creating a moving image from the user device 12 of a delivering user to create moving-image data and delivers the moving-image data to the user device 12 of a viewing user. Alternatively, a hybrid scheme in which two or more of these schemes are used may be used. A method for displaying a moving image on the user device 12 using the client rendering scheme (the second delivery scheme) will now be described.

User Device

The user devices 12 may include a system or device including a head-mounted display that is wearable on the user's head and a system or device that includes no head-mounted display. A user device 12 including a head-mounted display, if distinguished from other systems or devices, is referred to as “user device 120”, and if not distinguished, simply referred to as “user device 12”.

The head-mounted display included in the user device 12 includes a display to be viewed by the user. Examples include a non-transmissive device provided with a housing that covers both eyes and a transmissive device that allows a user to view not only virtual-space images but also real-world images. The non-transmissive head-mounted display may display an image for the left eye and an image for the right eye on one or a plurality of displays or may display a single image on a display. The non-transmissive head-mounted display displays virtual reality (VR) images. Examples of the transmissive head-mounted display include binocular glasses and monocular glasses, and the display is formed of a half mirror or a transparent material. The transmissive head-mounted display displays augmented reality (AR) images. The head-mounted display may also be a multifunctional telephone terminal, such as a smartphone, detachably fixed to a predetermined housing.

Each user device 120 includes a control unit 20, a storage 22 (a storage medium), and a communication interface (I/F) 23. The control unit 20 includes one or a plurality of operational circuits, such as a central processing unit (CPU), a graphic processing unit (GPU), and a neural network processing unit (NPU). The control unit 20 further includes a memory, which is a main storage (a recording medium) from and to which the operational circuit can read and write data. The memory includes a semiconductor memory. The control unit 20 may also be encompassed by or is a component of control circuitry and/or processing circuitry. The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The control unit 20 loads an operating system and other programs read from the storage 22 or an external storage into the memory and executes instructions retrieved from the memory. The communication I/F 23 transmits and receives data to/from the server 11 or other external devices via the network 14. The network 14 includes various networks, such as a local area network and the Internet. The control unit 20 functions as a mode acquisition unit, a moving-image creating unit, and a moving-image-data transmitting unit.

The storage 22 is an auxiliary storage (recording medium), such as a magnetic disk, an optical disk, and a semiconductor memory. The storage 22 may be a combination of a plurality of storages. The storage 22 stores a moving image program 220, avatar data 221 for drawing avatars, object data 222, and user management data 223.

The moving image program 220 is a program for delivering moving images and viewing moving images. The moving image program 220 executes either a delivery mode or a viewing mode on the basis of a user operation for specifying a mode. The control unit 20 obtains various pieces of data from the server 11 by executing the moving image program 220. Although the moving-image delivery function of the moving image program 220 is mainly described, the moving image program 220 includes the viewing mode for viewing moving images in addition to the delivery mode.

The avatar data 221 is three-dimensional-model data for drawing avatars that are models that imitate human figures or characters other than humans. The user device 12 obtains data for updating the avatar data 221 from the server 11 at a predetermined timing, such as when starting the moving image program 220. The avatar data includes data for drawing the avatar body and texture data on the attachment for the avatar body. The data for drawing the avatar body includes polygon data, skeletal frame data (bone) including a matrix for expressing the motion of the avatar, and a blend shape including the transformation of the model. The blend shape is a technique for forming a new shape by blending a plurality of models with the same structure, such the number of vertices, but different shapes. The bone includes the bones of the lower back, spine, neck, head, arms and hands, and legs of the avatar, and the bones of the eyes.

The avatar data 221 may include data for drawing a plurality of avatars bodies. In this case, the user can select an avatar corresponding to the user. The texture data includes a plurality of pieces of part data applicable to the avatar. For example, a plurality of pieces of part data are prepared for individual categories, such as “eyelids”, “pupils”, “eyebrows”, “ears”, and “clothes”. The user selects part data and applies the part data to the avatar body to create the avatar of the user. The part data selected by the user is stored in the storage 22.

The object data 222 is information on objects other than the avatar. The objects other than the avatar include wearable objects displayed on the display screen in association with specific parts of the avatar. Examples of the wearable objects include accessories and clothes attached to the wearable objects and other objects that can be attached to the avatar. Examples of the objects other than the avatar and the wearable objects include objects disposed at predetermined positions in the virtual space and animations of the backgrounds and fireworks.

The user management data 223 includes data on the user. The user management data 223 may include coins and points owned by the user and the delivery situation in associated with identification information on the user (user ID). The user management data 223 may include identification information on other users who have a friendship with the user and the degree of friendship with the other users. When the users approve each other, the other user is stored as a friend in the user management data 223.

The user device 120 further includes a sensor unit 24, a speaker 25, a microphone 26, and a display 28. The sensor unit 24 performs tracking to detect the motion of the user. The sensor unit 24 is disposed at the head-mounted display or an item other than the head-mounted display. Examples of the item other than the head-mounted display includes the parts of the user, such as arms and legs, and tools, such as a bat and a racket. An examples of the sensor unit 24 is Vive Tracker®. The sensor unit 24 disposed at the head-mounted display detects at least one of the orientation and the position of the terminal, such as a sensor unit of 3 degrees of freedom (3DoF) and 6 degrees of freedom (6DoF). An example of the sensor unit 24 is an inertial measurement unit (IMU). The inertial measurement unit detects at least one of the angle of rotation, the angular velocity, and the acceleration about an X-axis, a Y-axis, and a Z-axis that are three-dimensional coordinates in the real world. Examples of the inertial measurement unit include a gyroscope and an acceleration sensor. The sensor unit 24 may further include a sensor for detecting the absolute position, such as a global positioning system (GPS).

If the head-mounted display performs outside-in tracking, the sensor unit 24 may include an external sensor disposed outside the user's body in the tracking space. The sensor disposed at the head-mounted display and the external sensor detect the orientation and the position of the head-mounted display in cooperation. An example of the external sensor is Vive BaseStation®.

If the head-mounted display performs inside-out tracking, the sensor unit 24 may include a three-dimensional (3D) sensor capable of measuring three-dimensional information in the tracking space. This type of 3D sensor detects position information in the tracking space using a stereo system or a time-of-flight (ToF) system. The 3D sensor has a space mapping function for recognizing objects in the real space in which the user is present on the basis of the result of detection by the ToF sensor or a known other sensor and mapping the recognized objects on a spatial map.

The sensor unit 24 may include one or a plurality of sensors for detecting a face motion indicating a change in the user's facial expression. Face motions include motions, such as blinking and closing and opening of the mouth. The sensor unit 24 may be a known sensor. An example of the sensor unit 24 includes a ToF sensor for detecting the time of flight until the light emitted to the user is reflected by the user's face or the like to return, a camera that photographs the user's face, and an image processing unit that processes the data acquired by the camera. The sensor unit 24 may further include a red-green-blue (RGB) camera that images visible light and a near-infrared camera that images near-infrared light. Specifically, these cameras project tens of thousands of invisible dots on the user's face or the like with a dot projector. The sensor unit 24 detects the reflected light of the dot pattern, analyzes it to form a depth map of the face, and captures an infrared image of the face to capture accurate face data. The arithmetic processing unit of the sensor unit 24 generates various kinds of information on the basis of the depth map and the infrared image and compares the information with registered reference data to calculate the depths of the individual points of the face (the distances between the individual points and the near-infrared camera) and positional displacement other than the depths.

The sensor unit 24 may have a function for tracking the hands not only the user's face (hand tracking function). The hand tracking function tracks the outlines, joints, and so on of the user's fingers. The sensor unit 24 may include a sensor disposed in a glove that the user wears. The sensor unit 24 may further have an eye tracking function for detecting the positions of the user's pupils or irises.

Thus, known sensors may be used as the sensor unit 24, and the type and number of sensors are not limited. The position where the sensor unit 24 is disposed also depends on the type thereof. The detection data is hereinafter simply referred to as “tracking data” when the detection data is described without discrimination between body motions and face motions of the user.

The speaker 25 converts voice data to voice for output. The microphone 26 receives the voice of the user and converts the voice to voice data. The display 28 is disposed at the head-mounted display. The display 28 outputs various images according to an output instruction from the control unit 20.

A controller 27 inputs commands to the control unit 20. The controller 27 may include an operation button and an operation trigger. The controller 27 may include a sensor capable of detecting the position and orientation. If an input operation can be performed using hand tracking, line-of-sight detection, or the like, the controller 27 may be omitted.

The control unit 20 functions as an application managing unit 201 and an image processing unit 202 by executing the moving image program 220 stored in the storage 22. The application managing unit 201 executes main control of the moving image program 220. The application managing unit 201 obtains commands input by the user through the controller 27 or requests from the server 11 and outputs requests to the image processing unit 202 according the details of the requests. The application managing unit 201 transmits requests from the image processing unit 202 and various kinds of data to the server 11 or outputs tracking data obtained from the sensor unit 24 to the image processing unit 202. The application managing unit 201 stores various kinds of data received from the server 11 in the storage 22. The application managing unit 201 transmits moving-image creation data for creating a moving image to another user device 12 via the server 11. The moving-image creation data corresponds to moving-image display data.

The image processing unit 202 creates a virtual space image according to the orientation of the user's head using the tracking data obtained from the sensor unit 24 and outputs the created virtual space image to the display 28. In displaying not only an avatar corresponding the user but also an avatar corresponding to another user in the virtual space image, the image processing unit 202 obtains moving-image creation data from the other user device 12 via the server 11. The image processing unit 202 applies the tracking data obtained from the sensor unit 24 to the avatar data 221 corresponding to the user to create an animation. The image processing unit 202 applies the moving-image creation data to the avatar data 221 corresponding to the other delivering user via the server 11 to create the animation of the avatar corresponding to the other delivering user. The image processing unit 202 performs rendering of the avatar and also the objects other than the avatar. The rendering here refers to a rendering process including acquisition of the position of the virtual camera, perspective projection, and hidden surface removal (rasterization). The rendering may be at least one of the above processes and may include shading, texture mapping, and other processes.

In the delivery mode, the image processing unit 202 creates moving-image creation data and transmits the data to the server 11. In the viewing mode, the image processing unit 202 obtains the moving-image creation data from the server 11, creates a moving image on the basis of the moving-image creation data, and output the moving image to the display 28.

Server

Next, the server 11 will be described. The server 11 is used by a service provider or the like that provides a service for delivering moving images. The server 11 includes a control unit 30, a communication I/F 34, and a storage 35. The control unit 30 may also be encompassed by or is a component of control circuitry and/or processing circuitry. The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Since the control unit 30 has the same configuration as that of the control unit 20 of the user device 12, the description thereof will be omitted. Since the communication I/F 34 and the storage 35 have the same configurations as the respective configurations of the communication I/F 23 and the storage 22 of the user device 12, the description thereof will be omitted. The server 11 may be one or a plurality of servers. In other words, the function of the server 11 may be implemented by a server group composed of a plurality of servers. Alternatively, servers having equivalent functions provided at a plurality of places may constitute the server 11 by synchronizing with one another.

The storage 35 stores a delivery program 353. The control unit 30 functions as a delivery managing unit 301 and a purchase managing unit 302 by executing the delivery program 353.

The delivery managing unit 301 has a server function for delivering moving images to the user device 12 and transmitting and receiving various kinds of information on the view of the moving images. The delivery managing unit 301 stores the various data received from the user device 12 in the storage 35 and outputs a request to the purchase managing unit 302 on the basis of a purchase request or the like received from the user device 12.

Furthermore, the delivery managing unit 301 obtains data requested by the user device 12 from the storage 35 or the like and transmits the data to the user device 12. The delivery managing unit 301 transmits a list of moving images being delivered in response to the request from the user device 12 of the viewing user. The delivery managing unit 301 receives identification information on a moving image selected from the list from the user device 12 of the delivering user. The delivery managing unit 301 obtains moving-image creation data for displaying the moving image from the user device 12 of the user who delivers the selected moving image and transmits the moving-image creation data to the user device 12.

The delivery managing unit 301 receives a message or the like posted by the viewing user for the moving image being delivered. Then, the delivery managing unit 301 transmits the received posted message to the user device 12. The posted message contains the content of the message, the identification information on the viewing user who posted the message (for example, the user's account name) and posted date. The message displayed in the moving image includes not only the message sent from the viewing user but also a notification message that is automatically provided by the server 11.

The delivery managing unit 301 receives a request to output a gift to the moving image being viewed from the user device 12 of the viewing user. The gift requested to output includes an object provided from the viewing user to the delivering user who delivers the moving image and favorable evaluation of the moving image. The gift may be requested to output without or with getting paid for. Alternatively, the gift may get paid for when displayed in response to an output request. The delivery managing unit 301 transmits a gift output request to the user device 12 of the delivering user. At this time, data necessary for displaying the gift object may be transmitted to the user device 12 of the delivering user. The server 11 transmits a notification message, such as “User B has gifted fireworks”, to the user device 12 of the delivering user and the user device 12 of the viewing user at a predetermined timing, such as when receiving a gift output request.

The purchase managing unit 302 performs a process for purchasing an object or the like according to a user operation. The purchase process includes a process for paying the price (medium), such as a coin, point, ticket, or the like, that is available in the moving image program 220. The purchase process may include exchange, disposal, and transfer processes. The purchase managing unit 302 may execute a lottery (gacha) for electing a predetermined number of objects from a plurality of objects when getting paid for. The purchase managing unit 302 records the purchased objects in at least one of the user device 12 and the server 11 in association with the user. When the user purchased an object in the delivery mode (or a closet mode before delivery is started), the purchase managing unit 302 may store identification information on the purchased object in the storage 35 in association with the user who purchased the object. When the user purchased an object in the viewing mode, the purchase managing unit 302 may store the identification information on the purchased object as a gift in the storage 35 in association with the delivering user who delivers the moving image. Sales of objects available for purchase are distributed to the delivering user or the moving-image delivery service provider. When a gift to a game moving image is purchased, the sales are provided to at least one of the delivering user, the moving-image delivery service provider, and the game provider.

Next, the various kinds of data stored in the storage 35 of the server 11 will be described. The storage 35 stores user management data 350, avatar data 351, and object data 352, in addition to the delivery program 353.

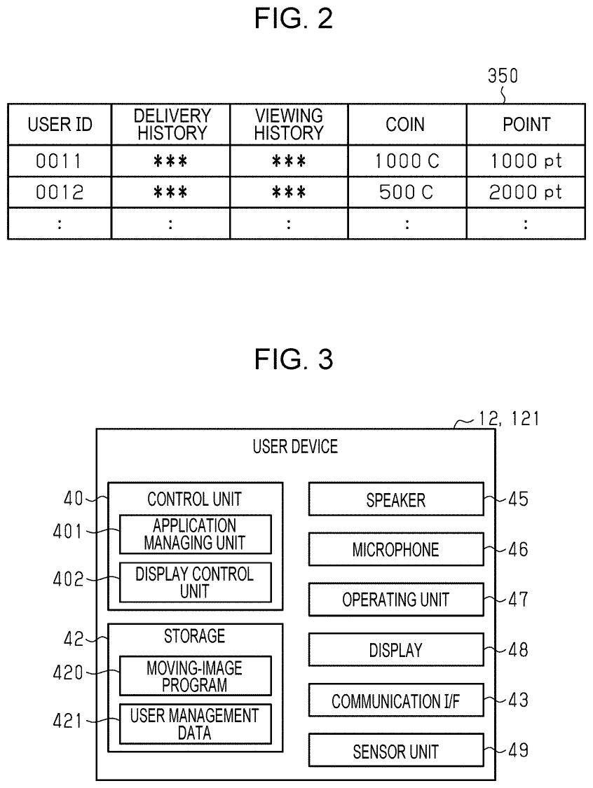

As shown in FIG. 2, the user management data 350 is information on the user who uses the moving image program 220. The user management data 350 may contain the identification information on the user (user ID), a delivery history indicating the delivery history of the moving image, a viewing history indicating a moving-mage viewing history, purchase media, such as a coins and a point. The user management data 350 is the master data of the user management data 223 of the user device 12. The user management data 350 may have the same content as that of the user management data 223 and may further contain other data.

The avatar data 351 is master data for drawing an avatar with the user device 12. The avatar data 351 is transmitted to the user device 12 in response to a request from the user device 12. The object data 352 is master data for drawing a gift object with the user device 12. The object data 352 is transmitted to the user device 12 in repose to a request from the user device 12. The object data 352 contains attribute information on the gift object in addition to data for drawing the gift, such as polygon data. The attribute information on the gift object contains the kind of the gift object and the position where the gift object is displayed.

Other User Devices

Referring to FIG. 3, a user device 121 including no head-mounted display will be described. The user device 12 not including the head-mounted display, if distinguished from the other user device, is hereinafter referred to as “user device 121”, and if not distinguished, simply referred to as “user device 12”. The user device 121 is an information processing apparatus capable of playing moving images, such as a smartphone (a multifunctional telephone terminal), a tablet terminal, a personal computer, a what-is-called stationary game console.

The user device 121 includes a control unit 40, a storage 42 (a storage medium), and a communication interface (I/F) 43. Since the hardware configurations thereof are the same as those of the control unit 20, the storage 22, and the communication I/F 23 of the user device 120, the description thereof will be omitted. The storage 42 stores a moving image program 420. The control unit 40 may be encompassed by or is a component of control circuitry and/or processing circuitry. The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The control unit 40 functions as an application managing unit 401 and a display control unit 402 by executing the moving image program 420. The application managing unit 401 transmits and receives data necessary for viewing a moving image to and from the server 11.

The display control unit 402 creates an animation using moving-image creation data received from the server 11 in the client rendering scheme. The display control unit 402 obtains the moving-image creation data from another user device 12 via the server 11. The display control unit 402 creates an animation by applying the moving-image creation data to the avatar data 221. The display control unit 402 renders the avatar and objects other than the avatar to create moving-image data containing the animation and outputs the moving-image data to the display 48.

The user device 121 includes a sensor unit 49. When the user device 121 is in the delivery mode, the display control unit 402 obtains various data from the sensor unit 49 and transmits moving-image creation data for creating the animation of the avatar and the objects to the server 11 according to the motion of the user.

The moving image program 420 causes the control unit 40 to implement a delivery function and a viewing function. The moving image program 420 executes either the delivery mode or the viewing mode according to the user's operation for specifying the mode. The user management data 421 contains data on the viewing user. The user management data 421 may contain user identification information (user ID), purchase media, such as coins and points.

The moving image program 220 installed in the user device 120 and the moving image program 420 installed in the user device 121 may be the same program or different programs. If the moving image programs 220 and 420 are the same program, the program implements or limit part of the functions according to the device in which the program is installed.

The user device 121 includes a speaker 45, a microphone 46, an operating unit 47, a display 48, and the sensor unit 49. The speaker 45 and the microphone 46 have the same configuration as those of the user device 120. Examples of the operating unit 47 includes a touch panel, a keyboard, and a mouse provided to the display 48. The display 48 may be integrated with the control unit 40 or the like or may be separate therefrom. The speaker 45 outputs voice data received from the server 11.

The sensor unit 49 includes one or a plurality of sensors, at least part of which may be the same as the sensor unit 24 of the user device 120. The sensor unit 49 includes one or a plurality of sensors that detect a face motion indicating a change in the user's facial expression and a body motion indicating a change in the position of the user's body relative to the sensor unit 49. The sensor unit 49 may include an RGB camera that images visible light and a near-infrared camera that images near-infrared light. The RGB camera and the near-infrared camera may be True Depth of “iphoneX®”, “LIDER” of “iPad Pro®”, or another ToF sensor mounted on a smartphone. Specifically, these cameras project tens of thousands of invisible dots on the user's face or the like with a dot projector. The sensor unit 49 detects the reflected light of the dot pattern, analyzes it to form the depth map of the face, and captures an infrared image of the face to capture accurate face data. The arithmetic processing unit of the sensor unit 49 generates various kinds of information on the basis of the depth map and the infrared image and compares the information with registered reference data to calculate the depths of the individual points of the face (the distances between the individual points and the near-infrared camera) and positional displacement other than the depths.

Creating Delivery Moving Image

Avatar and Camera

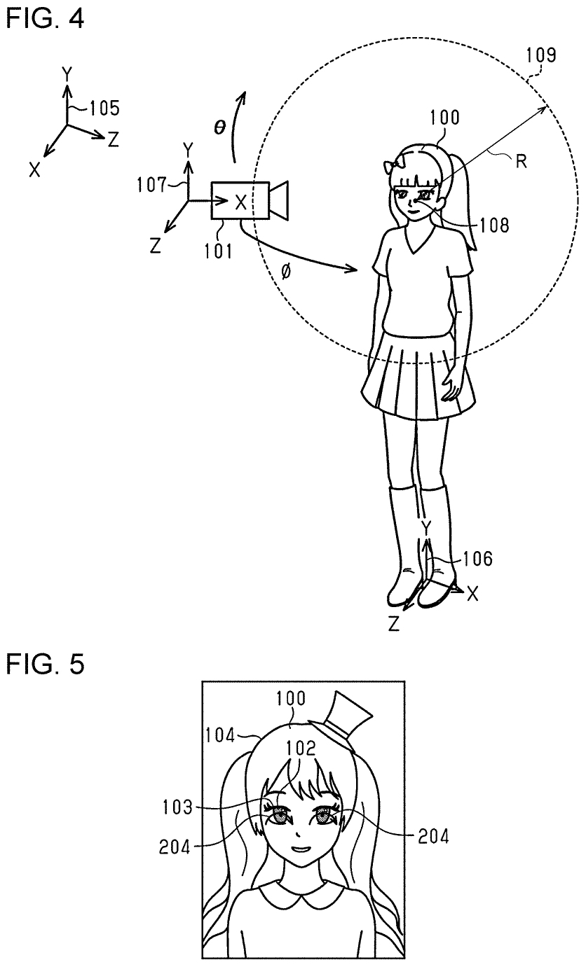

Referring to FIGS. 4 and 5, the coordinate system in the virtual space in which an avatar 100 is disposed will be described. As shown in FIG. 4, a world coordinate system 105 is set in the virtual space. The world coordinate system 105 is a coordinate system for defining positions in the entire virtual space. For example, the position of an object, such as the avatar 100, can be specified in the world coordinate system 105. A local coordinate system 106 is set for a specific object in the virtual space. The local coordinate system 106 uses the position of the object as the origin point. The use of the local coordinate system 106 allows controlling the orientation and so on of the object. The orientation of the avatar 100 can be changed in the direction of rotation about the Y-axis of the local coordinate system on the basis of the motion of the delivering user. The movable parts, such as the arms, legs, and head, can be moved according to the motion of the delivering user. The posture of the avatar 100 can be changed in the Y-axis direction, for example, from an erect posture to a bent posture. The avatar 100 can also be moved in the virtual space in the X-axis direction and the Z-axis direction of the world coordinate system 105 according to an operation of the delivering user on the controller 27 or the motion of the delivering user. In displaying an augmented reality image on the head-mounted display, the augmented reality image is displayed on a reality image captured by a camera provided at the user device 12. In this case, the orientation of the avatar 100 can be changed on the basis of the walking or the like of the viewing user who operates the position of the camera of the user device 12. The motion of the avatar 100 is not limited to the above motion.

A camera 101 for photographing the avatar 100 is placed in the virtual space. A camera coordinate system 107 with the position of the camera 101 as the origin point is set for the camera 101. When an image observed through the camera 101 is created, first, the coordinates of the object disposed in the virtual space are converted to the coordinates of the camera coordinate system 107. The camera coordinate system 107 has an X-axis parallel to the optical axis of the camera 101, a Y-axis that is parallel or substantially parallel to the vertical direction, and a Z-axis. The camera 101 corresponds to a virtual camera in the claims.

When a plurality of avatars 100 are present in the virtual space, the image processing unit 202 sets the camera 101 for each avatar 100 according to the mode of the moving image. The cameras 101 are disposed at any positions in a camera range 109 that is a distance R away from the center point 108, which is determined according to the number and positions of the avatars 100. In other words, the cameras 101 are positioned in the spherical camera range 109 centered on the center point 108 and having a radius equal to the distance R. Each camera 101 can be moved in the camera range 109 according to an operation of the delivering user on the controller 27. The optical axes of the cameras 101 are directed to the center point 108. In other words, the cameras 101 are disposed so as to point at the center point 108.

The position of each camera 101 in the spherical camera range 109 can be specified by the azimuth angle φ, which is the angle in the horizontal direction of the camera range 109, and the elevation angle θ, which is the angle in the direction parallel to the vertical direction. The azimuth angle φ is a yaw angle which is the angle of rotation of the avatar 100 about the Y-axis parallel to the vertical direction of the local coordinate system 106. The elevation angle θ is a pitch angle which is the angle of rotation of the avatar 100 about the X-axis of the local coordinate system 106. The cameras 101 are not rolled about the Z-axis parallel to the depth direction of the local coordinate system 106. Limiting the rolling of the cameras 101 prevents the delivering user who wears the head-mounted display from feeling uncomfortable.

The image processing unit 202 limits the elevation angle θ of the camera 101 in a predetermined range. If the middle of the curve connecting the upper and lower vertices of the camera range 109 is 0°, the allowable range of the elevation angle θ is set in the angle range with a lower limit of −30° and an upper limit of +80°. This is because the avatar 100 has a part that looks unnatural when viewed from a certain elevation angle θ and a part that the delivery user does not want the viewing user to see. Setting the elevation angle θ to a predetermined range in this manner allows for delivering a moving image that does not look strange without displaying the part that looks unnatural or the part that the delivering user does not want to show.

Referring next to FIG. 5, the behavior of the pupils 102 of the avatar 100 will be described. The eyes 103 of the avatar 100 have a master-servant relationship with the head 104 of the avatar 100 and move following the motion of the head 104. The pupils 102 of the avatar 100 can behave independently in a predetermined range. The image processing unit 202 is capable of moving the pupils 102 in the direction of rotation 204 (the direction of rolling) about the Z-axis parallel to the depth direction of the avatar 100 in the local coordinate system 106. In place of or in addition to this, the pupils 102 may be translatable in the X-axis direction and the Y-axis direction.

An example of a method for controlling the behavior of the pupils 102 (eyeballs) is a method of rotating the bones set in association with the pupils 102. The bones associated with the pupils 102 are associated with a specific object, which is the target of the line of sight”, and the master-servant relationship between the specific object (parent) and the pupils 102 (child) is set so that the pupils 102 follow the motion of the specific object. In general implementation, an Euler angle indicating any direction can be determined via quaternion for controlling the postures of eyeballs with respect to a specific vector by using a LookAt function or a Quaternion. Slerp function for a vector for controlling the postures of the eyeballs. Not simple control of the rotational angle but a control system in which the actual human body is imitated, and muscles which are controlled in two axes about the angle are imitated is also possible. It is more preferable that one point with no three-dimensional breakdown be seen with the right and left eyeballs. A more detailed emotional expression is possible by reproducing micro-ocular movements by intentionally shifting the targets of the two eyeballs or adding noise such as tremors. Also for an object that is not a point, an orthogonal vector and the normal to a plane can be obtained, allowing similar processing. This allows the image processing unit 202 to move the pupils 102 following the motion of a specific object. Alternatively, the bones associated with the pupils 102 are associated with not the object but a predetermined position in the virtual space. This allows the image processing unit 202 to point the pupils 102 to the predetermined position even while the avatar 100 is moving.

The specific object to which the line of sight is directed is another avatar 100 facing the avatar 100, the camera 101 associated with the avatar 100, and the camera 101 shared by the plurality of avatars 100. If the specific object is the face or the pupils 102 of another avatar 100, the avatar 100 directs the line of sight to the other avatar 100. If the pupils 102 of both avatars 100 are directed to each other, the avatars 100 come into eye-contact with each other.

If the pupils 102 of the avatar 100 are associated with the camera 101 associated with the avatar 100, the pupils 102 are directed to the camera 101 even if the avatar 100 moves. The image processing unit 202 creates line-of-sight information on the avatar 100 specified by the positions of the pupils 102 of the avatar 100.

Outline of Collaboration Delivery

Collaboration delivery, which is one of methods of directing moving images, will be described. The user device 12 of the delivering user is capable of delivering a moving image in which a single avatar 100 appears and a moving image including a plurality of avatars 100 present in the same virtual space. Delivery of the moving image in which a plurality of avatars 100 act together is hereinafter referred to as “collaboration delivery”.

The collaboration delivery is implemented when the user device 12 of a delivering user transmits a request for collaboration delivery to the user device 12 of a main delivering user who performs collaboration delivery, and the request is approved by the main delivering user. The main delivering user who performs collaboration delivery is hereinafter referred to as “host user”, and another delivering user who participates in the collaboration delivery is referred to as “guest user”.

In the collaboration delivery, the host user can select one of a plurality of modes. A first mode, a second mode, or a third mode can be selected. These modes differ in the target of the line of sight of the avatar 100. In the first mode and the second mode, the target of the line of sight differs among the avatars 100. In other words, when a moving image is delivered using a multifunctional telephone terminal, such as a smartphone, the camera 101 is placed in front of the avatar 100 in the virtual space corresponding to the delivering user, and the delivering user delivers the moving image while facing the multifunctional telephone terminal. In other words, since the delivering user hardly moves, and the positional relationship between the avatar 100 and the camera 101 in the virtual space is fixed, the delivering user can act without particular concern for the position of the camera 101 set in the virtual space. If the delivering user wears a head-mounted display, the delivering user acts while viewing an image of the virtual space displayed on the head-mounted display, so that the positional relationship between the avatar 100 and the camera 101 changes. This can cause the delivering user to lose sight of the position of the camera 101. If the delivering user delivers the moving image while losing sight of the camera 101, the delivering user may speak to the viewing user without facing the camera 101, or the face of the avatar 100 may be invisible for a long time, which can result in delivery of a moving image that makes the viewing user feel strange. However, if the delivering user is constantly aware of the position of the camera 101, the delivering user cannot concentrate his/her attention to performance. For this reason, automatically directing the line of sight of the avatar 100 to the specific object or a predetermined position with the image processing unit 202 allows for delivering a moving image that does not make the viewing user feel strange, allowing the delivering user to concentrate on the performance.

The first mode is a mode in which the plurality of avatars 100 look at the corresponding cameras 101. The cameras 101 corresponding to the individual avatars 100 are disposed at different positions. The cameras 101 may be fixed to predetermined positions. Each cameras 101 may be moved on the basis of the operation of the delivering user on the controller 27. In this case, the delivering users can specify the elevation angle θ and the azimuth angle φ of the camera 101 by operating the controller 27. The first mode is a camera eye mode.

The second mode is a mode in which each avatar 100 looks at an avatar 100 that acts together. When two avatars 100 perform collaboration delivery, one of the avatars 100 looks at the position of the other avatar 100. When three or more avatars 100 perform collaboration delivery, they look at the middle position of all the avatars 100. Alternatively, each avatar 100 looks at the other closest avatar 100. The second mode is an eye-contact mode.

Also in the second mode, the cameras 101 corresponding to the individual avatars 100 may be fixed to different positions. The cameras 101 corresponding to the individual avatars 100 may be moved according to the operation of the delivering users on the controller 27.

The moving-image creation data for creating a moving image of the camera 101 set for each avatar 100 as described above is created by the user device 12 of the delivering user corresponding to the avatar 100. Alternatively, only the user device 12 of the host user may create moving-image creation data for creating a moving image seen from the camera 101 set for each avatar 100.

The third mode is a mode in which a plurality of avatars 100 look at a common camera 101. An example of the common camera 101 is a bird's eye view camera that looks down at the plurality of avatars 100 from above the avatars 100. The common camera may be fixed to a predetermined position and may be moved according the operation of the host user or the guest user on the controller 27. When an augmented reality image is displayed, the camera of the viewing user device 12B serves as the common camera 101.

The image processing unit 202 applies one mode to collaboration delivery on the basis of the operation of the host user. If the first mode or the second mode is selected, a plurality of cameras 101 is set. The plurality of cameras 101 photographs the same virtual space from different positions. The number of cameras 101 may be the same as the number of avatars 100 or may be more than one and different from the number of avatars 100.

When the user views a moving image using the user device 120 including the head-mounted display, the virtual space image to be output on the head-mounted display is changed according to a change in the orientation of the user's head or the like. However, when the user device 12 outputs a moving image to which one of the first mode, the second mode, and the third mode is applied, the user device 12 may output the moving image to a two-dimensional area, such as a screen, set in a virtual space while displaying a virtual space image according to the orientation of the user's head or the like. Alternatively, the user device 12 may output a moving image to which one of the first mode, the second mode, and the third mode is applied on the entire surface of the display 28.

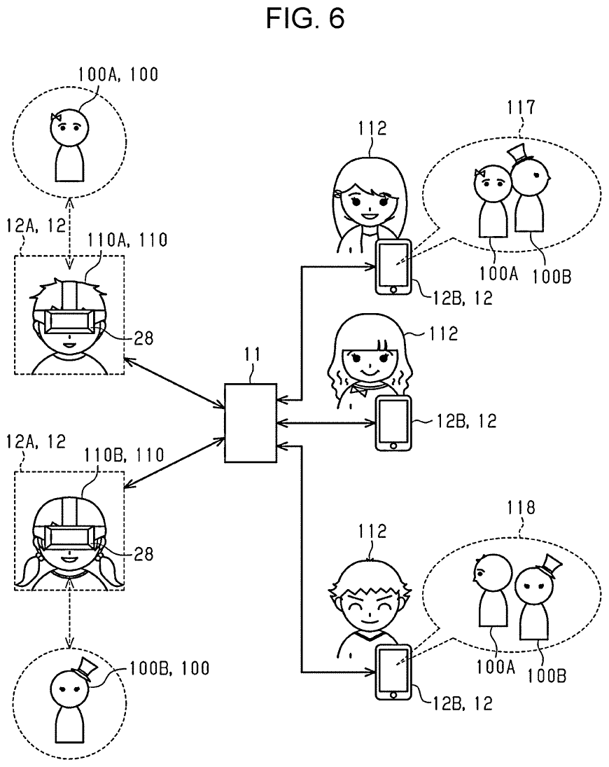

FIG. 6 schematically illustrates a state in which a plurality of viewing users 112 views moving images of collaboration delivery in which an avatar 100A corresponding to a delivering user 110A and an avatar 100B corresponding to a delivering user 110B act together. When the user device 12 that the delivering user 110 uses is distinguished, it will be referred to as a delivering user device 12A regardless of whether a head-mounted display is included. When the user device 12 that the viewing user 112 uses is distinguished, it will be referred to as a viewing user device 12B regardless of whether a head-mounted display is included.

Each viewing user 112 selects a desired moving image from a delivery list screen. The viewing user device 12B issues a request to view a moving image to the server 11. The viewing user device 12B obtains specified moving-image creation data from the server 11 and creates a moving image and displays it on the display 48. The moving image is a moving image in the mode specified by the delivering user device 12A of the host user. When the first mode or the second mode is selected as the mode for the moving image, the viewing user 112 can view moving images seen from different angles even if they are moving images in which the same avatars 100 act together because a plurality of cameras 101 are set around the avatars 100.

The viewing user 112 can select one of moving images 117 and 118 by selecting one of the avatars 100A and 100B or one of the plurality of cameras 101 on the screen displayed on the viewing user device 12B. One viewing user device 12B displays the moving image 117 photographed by one camera 101. The other viewing user device 12B displays the moving image 118 photographed by another camera 101. In other words, the moving images 117 and 118 displayed on the viewing user devices 12B are images of the avatars 100A and 100B photographed from different positions and having the same voice.

For example, one viewing user 112 is supposed to view a moving image of the desired avatar 100A taken by the nearby camera 101, and the other viewing user 112 is supposed to view a moving image of the desired avatar 100B taken by the nearby camera 101. The viewing user 112 can view a moving image taken by one camera 101 and thereafter can view a moving image taken by another camera 101 during moving image delivery. In other words, the viewing user 112 can view moving images taken by different cameras 101 during moving image delivery.

Camera Range in Collaboration Delivery

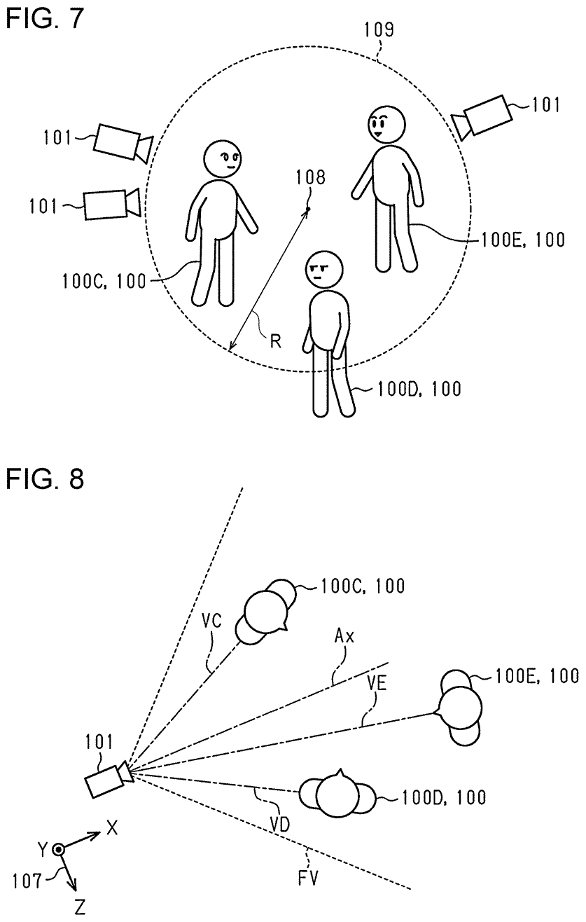

Referring to FIG. 7, camera positions in collaboration delivery will be described. The image processing unit 202 also sets the camera range 109 in collaboration delivery and set the cameras 101 on the camera range 109.

FIG. 7 illustrates collaboration delivery using three avatars 100C to 100E. The same number of cameras 101 as the number of avatars 100C to 100E are set on the camera range 109. The center point 108 of the camera range 109 is determined on the basis of the positions of the avatars 100C to 100E. For example, if the coordinates of predetermined parts of the avatars 100C to 100E in the local coordinate system 106 are (Xc, Yc, Zc), (Xd, Yd, Zd), and (Xe, Ye, Ze), respectively, the center point 108 is set to the center thereof, i.e., {(Xc+Xd+Xe)/3, (Yc+Yd+Ye)/3, (Zc+Zd+Ze)/3}. The distance R, which is the radius of the camera range 109, is set so that the predetermined positions of the avatars 100C to 100E are included in the camera range 109. Specifically, the distance R is set so that all of the outline of the avatar 100 and the center and predetermined parts of the avatar 100, such as the neck, the head, and the stomach are within the camera range 109. The image processing unit 202 repeatedly calculates the center point 108 and the distance R. The center point 108 changes as the avatars 100C to 100E move. When the avatars 100C to 100E approach each other and the relative distance decreases, the distance R decreases. When the avatars 100C to 100E come apart from each other and the relative distance increases, the distance R increases. Also in collaboration delivery of more or less than three avatars 100, the image processing unit 202 sets the camera range 109 in the same manner.

Viewing Angle of Camera in Collaboration Delivery

Referring to FIG. 8, the viewing angle of the camera 101 will be described. The viewing angle FV of the camera 101 is a horizontal angle about the optical axis Ax. The image processing unit 202 increases or decreases the viewing angle FV according to the positions of the avatars 100 that act together so that all of the avatars 100 are included. Specifically, if the relative distance among the avatars 100 is large, the image processing unit 202 increases the distance R of the camera range 109 (see FIG. 7) and increases the viewing angle FV. If the relative distance among the avatars 100 is small, the image processing unit 202 decreases the distance R of the camera range 109 (see FIG. 7) and reduces the viewing angle FV.

FIG. 8 illustrates collaboration delivery of three avatars 100C to 100E. The camera 101 may be within the camera range 109. The image processing unit 202 obtains vectors VC to VE from the origin point of the camera 101 to the avatars 100C to 100E and normalizes the vectors VC to VE. For example, the vectors VC to VE are directed to the respective center positions or the centers of gravity of the avatars 100C to 100E. The image processing unit 202 obtains the inner products of the individual normalized vectors VC to VE and the Z-axis which is horizontal, as is the optical axis Ax of the camera 101, and perpendicular to the optical axis Ax. The image processing unit 202 determines whether each avatar 100 is on the left or the right of the optical axis Ax of the camera 101 from the value of the inner product. The image processing unit 202 also determines an avatar 100 distant from the optical axis Ax of the camera 101 from the value of the inner product.

Specifically, the image processing unit 202 normalizes the vectors VC to VE for all of the avatars 100 that perform collaboration delivery. The image processing unit 202 obtains the inner products of the vectors VC to VE and the Z-axis perpendicular to the optical axis Ax of the camera 101. The image processing unite can determine whether each avatar 100 is on the left or the right of the optical axis Ax from the value of the inner products. For example, the avatar 100D is determined to be positioned at an angle larger than 0° and less than 90° with respect to the Z-axis because the value of the inner product of the vector VD and the Z-axis is positive. In other words, the avatar 100D is determined to be located on the right of the optical axis Ax perpendicular to the Z-axis. The avatar 100C is determined to be positioned at an angle larger than 90° and less than 180° with respect to the Z-axis because the value of the inner product of the vector VC and the Z-axis is negative. In other words, the avatar 100C is determined to be positioned on the left of the optical axis Ax perpendicular to the Z-axis.

The image processing unit 202 also determines the greatest absolute value of the obtained inner products. The vector that gives the greatest absolute value forms the largest angle with respect to the optical axis Ax. The image processing unit 202 calculates a large angle which is the angle formed by the vector and the optical axis Ax and determines an angle larger than two or more times larger than the large angle about the optical axis Ax as a viewing angle FV as the viewing angle FV. For example, if the large angle is 30°, the viewing angle FV is set to 60° or the angle obtained by adding a predetermined offset value to 60°. The offset value may be a fixed value, such as 10°. Alternatively, the offset value may be a value determined according to the viewing angle FV. For example, if the viewing angle is 60°, the offset value may be a predetermined percentage (for example, 2%) thereof.

The image processing unit 202 repeatedly calculates the viewing angle FV on the basis of detection data obtained from the sensor unit 24 of the delivering user device 12A and the position data on the avatar 100 obtained from the delivering user device 12A of another delivering user participating in the collaboration delivery. Because of this, if the position of the avatar 100 changes, the viewing angle FV also changes according to the change. For example, when the relative distance among the avatars 100 increases, the viewing angle FV is increased, and when the relative distance among the avatars 100 decreases, the viewing angle FV is decreased.

The elevation angle when the camera 101 is fixed to a position is hereinafter referred to as “camera elevation angle” to distinguish it from the elevation angle θ of the camera position on the camera range 109 described above. The camera elevation angle is the angle in the direction of rotation about the Z-axis of the camera coordinate system 107 and in the substantially vertical direction. The elevation angle of the camera 101 is constant.

Preview Screen in Collaboration Delivery

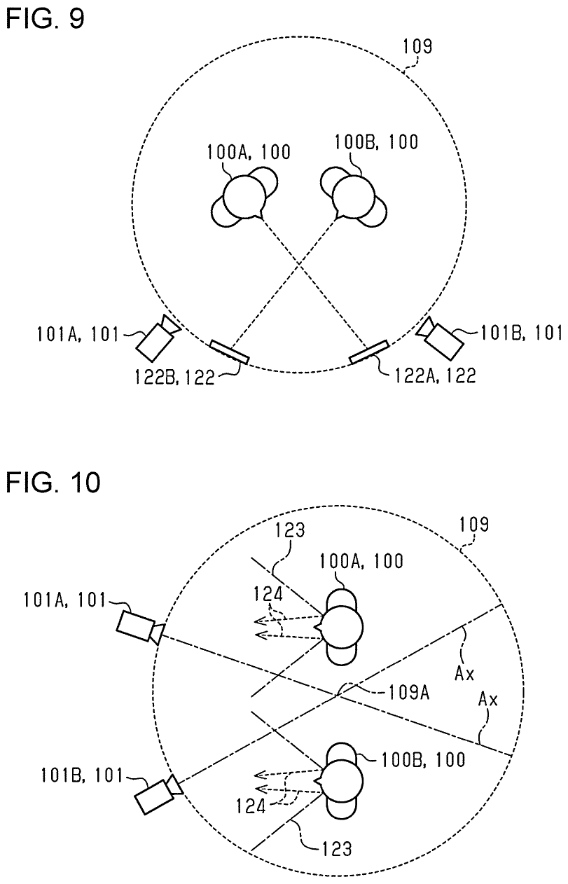

Referring to FIG. 9, display of a preview screen will be described. The preview screen is an image used by the delivering user 110 who wears a head-mounted display to check the viewing screen of the moving image that the delivering user 110 delivers. In other words, the display 28 of the head-mounted display displays a screen according to the position and orientation of the head of the delivering user 110. The screen displayed at that time differs from a viewing screen displayed on the viewing user device 12B. In other words, when the delivering user 110 who wears a head-mounted display delivers a moving image, the delivering user 110 cannot view the viewing screen with a known moving-image delivery application. However, in collaboration delivery, the avatar 100 corresponding to the delivering user 110 may hide another avatar 100 that is present on the back. Furthermore, if the avatar 100 has its back to the camera 101, it is difficult for the delivering user 110 to see where the avatar 100 is displayed on the viewing screen. For this reason, it is preferable that the delivering user 110 give a performance while viewing the viewing screen to deliver a moving image that the delivering user 110 intends. For this reason, the viewing screen is displayed together with a virtual space image according to the position of the head of the delivering user 110 as a preview screen 122.

The preview screen 122 is set for each avatar 100. The image processing unit 202 displays a moving image viewed from a camera 101A corresponding to the avatar 100A as a preview screen 122A for the delivering user 110A corresponding to the avatar 100A. The preview screen 122A is set at a position in front of or the vicinity of the avatar 100A and a certain distance away from the avatar 100A. The image processing unit 202 displays a moving image viewed from a camera 101B corresponding to the avatar 100B as a preview screen 122B for the delivering user 110B corresponding to the avatar 100B.

This allows the delivering user 110 to see the preview screen 122 displayed in front while viewing the virtual space image and giving a performance. This allows the delivering user 110 to give a performance while changing the angle and position when the avatar 100 is displayed on the viewing screen. The preview screen 122 may be displayed off in straight front of the avatar 100. In this case, the preview screen 122 can be displayed so as not to overlap with the object that the delivering user 110 wants to view in the virtual space or the background as much as possible.

Modes of Collaboration Delivery

Next, the first mode, the second mode, and the third mode to be selected in collaboration delivery will be described in detail. A delivering user device 12A that delivers a moving image to which one of the first mode, the second mode, and the third mode is applied will be described as the user device 120 including a head-mounted display. The viewing user device 12B will be described as the user device 120 including a head-mounted display or the user device 121 with no head-mounted display.

First Mode

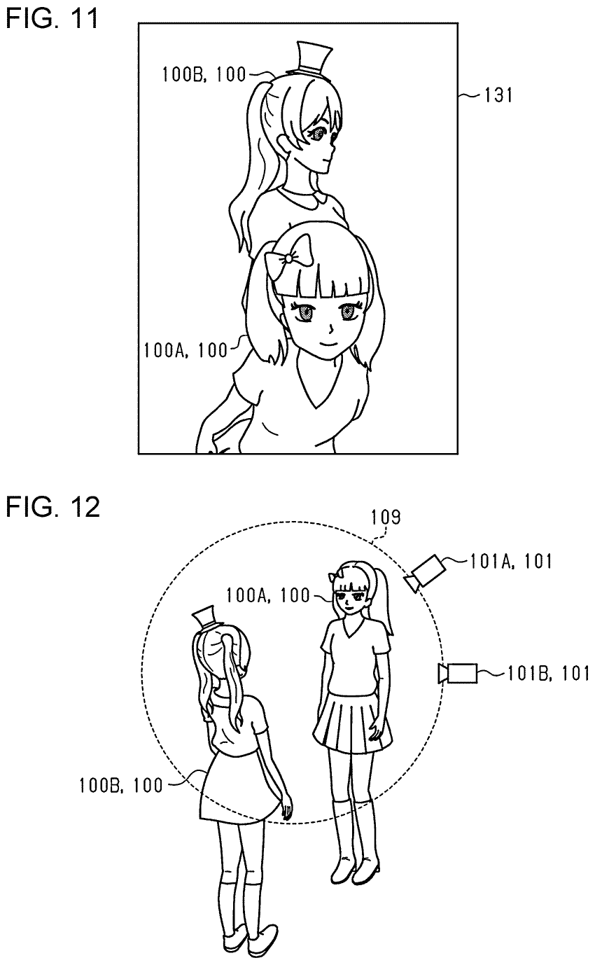

Referring to FIGS. 10 and 11, the first mode will be described. In the first mode, the image processing unit 202 determines whether the camera 101A corresponding to the avatar 100A is present in the field of view 123 of the avatar 100A, as shown in FIG. 10. The field of view 123 of the avatar 100A is a predetermined angular range in front of the avatar 100A. Direction vectors 124 indicating the directions of the lines of sight of the avatar 100A are set for the right eye and the left eye of the avatar 100A. These direction vectors 124 are within the field of view 123. When the camera 101 is within the field of view 123 of the avatar 100A, the pupils 102 of the avatar 100A are directed to the camera 101A corresponding to the avatar 100A as indicated by the direction vectors 124. Specifically, the central axes of the bones of the pupils 102 are directed to the camera 101A. In contrast, when the camera 101 is outside the field of view 123 of the avatar 100A, the pupils 102 cannot be directed to the camera 101. For this reason, the pupils 102 are moved to predetermined positions or an end close to the camera 101. Alternatively, the movement of the pupils 102 is temporarily stopped. Likewise, the image processing unit 202 directs the pupils 102 of the avatar 100B to the camera 101B corresponding to the avatar 100B. The cameras 101A and 101B point to the center point 109A of the camera range 109. In other words, the center point 109A of the camera range 109 is located on the optical axes Ax of the cameras 101A and 101B.

FIG. 11 illustrates a viewing screen 131 viewed from the camera 101A corresponding to the avatar 100A in the first mode. The viewing screen 131 that the delivering user 110A delivers displays the avatar 100A that points the line of sight at the camera 101A. The line of sight of the other avatar 100B points at the camera 101B corresponding to the avatar 100B. In other words, the viewing user 112 who views a moving image captured by the camera 101A views a moving image in which the avatar 100A directs the line of sight to the camera 101A. The viewing user device 12B displays the viewing screen on the display 48 and outputs the voices of the delivering users 110A and 110B from the speaker 45. This allows the viewing user 112 to view the moving image in which the avatar 100A appears together with the other avatar 100B and faces the viewing user 112 even while moving. Since the avatar 100A points at the camera 101A, the delivering user 110A can concentrate on the performance, such as moving around freely, without regard to the position of the camera 101A. In contrast, the viewing user 112 who views a moving image captured by the camera 101B views a moving image in which the avatar 100B directs the line of sight to the camera 101B.

Second Mode

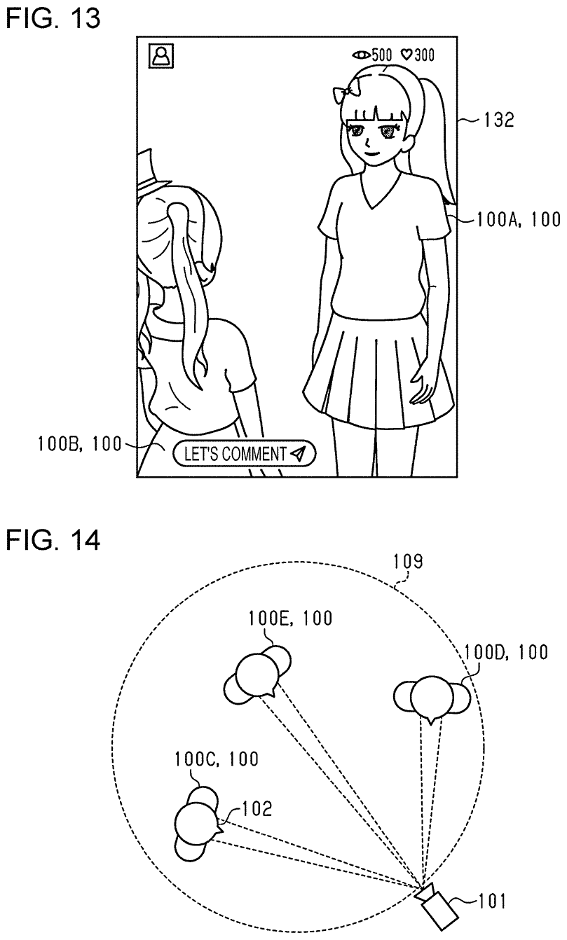

Referring next to FIGS. 12 and 13, the second mode will be described. FIG. 12 illustrates collaboration delivery of the two avatars 100A and 100B. In the second mode, the image processing unit 202 points the pupils 102 of the avatar 100A to the other avatar 100B. For the avatar 100B, the image processing unit 202 points the pupils 102 of the avatar 100B to the avatar 100A. The camera 101A corresponding to the avatar 100A and the camera 101B corresponding to the avatar 100B may be fixed to predetermined positions. The cameras 101A and 101B may be moved according to the operation of the delivering users 110 corresponding to the avatars 100A and 100B on the controllers 27.

When three or more avatars 100 are present in the virtual space, each avatar 100 may direct the line of sight to another avatar 100 closest to the avatar 100. The image processing unit 202 obtains the coordinates in the local coordinate system 106 for each avatar 100 and determines an avatar 100 closest to the avatar 100 on the basis of the obtained coordinates. Alternatively, the image processing unit 202 may refer to the user management data 223, and when another avatar 100 having a friendship with the avatar 100 of the delivering user 110 is within the predetermined range of the avatar 100 of the delivering user 110, the image processing unit 202 may direct the line of sight to the avatar 100. When the avatar 100 of a delivering user 110 with highly friendly relation is present in a predetermined range of the avatar 100 of the delivering user 110, the image processing unit 202 may direct the line of sight to the avatar 100. Alternatively, the delivering user 110 may specify another avatar 100 to which the delivering user 110 directs the line of sight. The specification of the avatar 100 is executed using the controller 27 or when the delivering user 110 continuously gazes at the avatar 100 for a predetermined time.

The cameras 101A and 101B point at the center point 108 of the camera range 109 (see FIG. 7), as described above. The distance R of the camera range 109 and the viewing angle FV of the camera 101 are set according to the relative distance between the avatars 100A and 100B. This allows for creating a moving image in which the talking avatars 100A and 100B are within the viewing angle FV even if the delivering user 110 does not adjust the positions of the avatars 100A and 100B, allowing the delivering user 110 to concentrate on the performance.

FIG. 13 illustrates an example of a viewing screen 132 viewed from the camera 101A in the second mode. The viewing screen 132 that the delivering user 110A delivers an image in which at least the avatar 100A directs the line of sight to the avatar 100B. The line of sight of the avatar 100B is directed to the avatar 100A. For example, when the avatars 100A and 100B have a talk with each other side by side while viewing the same camera 101, the viewing screen 132 exhibits a screen in which the avatars 100A and 100B have a talk with each other while talking to the viewing user 112. Making the avatars 100A and 100B have a talk while looking at each other as described above allows expressing a state in which the avatars 100A and 100B talk only to each other naturally.

Third Mode

Referring next to FIG. 14, the third mode will be described. As shown in FIG. 14, in the third mode, the image processing unit 202 directs the pupils 102 of the avatars 100C to 100E to one camera 101. In one example, the camera 101 is set above the positions of the eyes of the avatars 100C to 100E. The camera 101 may be moved according to the operation of the host user or the like on the controller 27.

Directing the lines of sight of the avatars 100C to 100E to the common camera 101 in this way allows taking a ceremonial photograph or the like. The delivering user 110 who wears a head-mounted display generally brings the field of view in line with the head and eyes of the avatar 100 that the delivering user 110 talks to. Thus, the talking delivering user 110 tends to gaze in front or the conversational partner, making it difficult to locate the camera 101 accurately. It is difficult for humans to continue to gaze at the same point, causing a phenomenon in which they momentarily shift their lines of sight to the surroundings or the like. For this reason, it is difficult for a plurality of users to continue to gaze at the same point, and the users will continue to take unnatural postures. An image in which everyone gazes at a single point as described above is unnatural. However, it is effective as an image having appeal power that attracts the attention of the viewing user 112, such as a commemorative picture, an event attendance certificate picture, or thumbnail images illustrating the details of a program.

While the first mode, the second mode, and the third mode can be set before delivery of the moving image, the modes can be selected according to an instruction from the delivering user 110. The modes can be selected by operating the controller 27 or selecting operation buttons or the like displayed in the virtual space. For example, when starting to deliver a moving image, the host user sets the second mode, and when taking a ceremonial photograph while delivering a moving image, sets the third mode. When the mode is changed, the image processing unit 202 of the delivering user device 12A changes the target of the line of sight according to the mode. When the mode is switched from the first mode to the second mode, the targets of the lines of sight are changed from the cameras 101 corresponding to the individual avatars 100 to the face or pupils 102 of another avatar 100. When the mode is switched from the first mode to the third mode, the targets of the lines of sight are changed from the cameras 101 corresponding to the individual avatars 100 to the common camera 101. Making the mode switchable in one delivery allows for various expressions.

Delivery List Screen

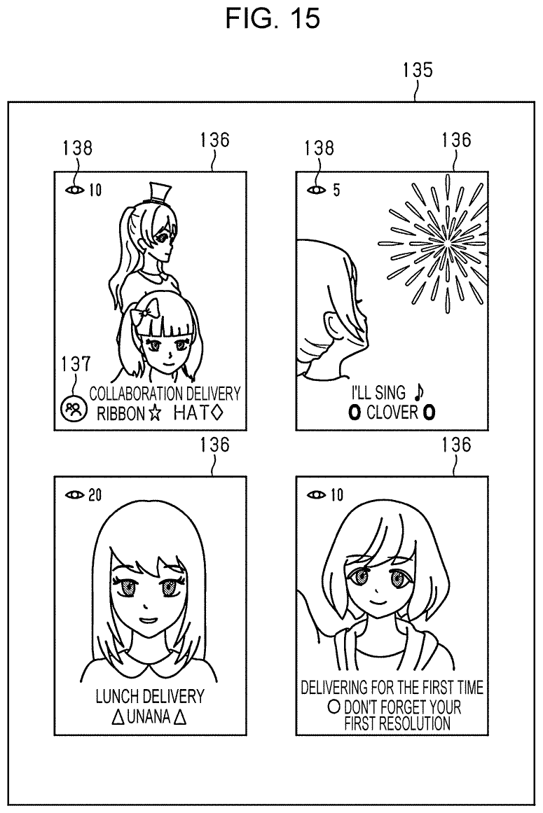

Referring to FIG. 15, an example of a delivery list screen 135 displayed on the viewing user device 12B will be described. The application managing unit 401 of the viewing user device 12B obtains a delivery list from the server 11 on the basis of the operation performed by the viewing user 112. The display control unit 402 displays the delivery list screen 135 on the display 48. The delivery list screen 135 displays thumbnail images 136 of a moving image being delivered.

In collaboration delivery, a mark 137 indicating that the image is delivered in collaboration delivery is displayed for one thumbnail image 136 at the upper left of FIG. 15. This thumbnail image 136 displays attribute information on the moving image. The attribute information includes a viewing-user-count display portion 138 that indicates the number of viewing users 112 who are viewing the moving image.

The viewing user 112 selects a thumbnail image 136 from the delivery list screen 135. When the thumbnail image 136 is selected, the display control unit 402 displays a screen for selecting avatars 100 that participate in the collaboration delivery. Suppose that “avatar A” and “avatar B” participate in the collaboration delivery. If the viewing user 112 selects “avatar A”, the viewing user device 12B requests the server 11 to send moving-image data in which the camera-coordinate origin point (optical center) is centered on the camera 101 associated with “avatar A”. In other words, the viewing user device 12B requests moving-image data viewed from the camera 101. When the viewing user device 12B receives the moving-image data from the server 11, the viewing user device 12B displays a moving image with the camera 101 corresponding to “avatar A” as the coordinate origin point on the display 48. In contrast, if the viewing user 112 selects “avatar B”, the viewing user device 12B obtains moving-image data in which the camera-coordinate origin point is centered on the camera 101 associated with “avatar B” from the server 11. The viewing user device 12B displays a moving image in which the camera 101 corresponding to “avatar B” as the camera-coordinate origin point on the display 48. In switching between cameras 101, the viewing user 112 returns to the delivery list screen 135 and re-selects the avatar 100. Alternatively, a button for switching between the cameras 101 may be displayed on the viewing screen. The viewing user 112 switches between the cameras 101 by selecting the buttons. In other words, the viewing user 112 selects a favorite avatar 100 or a supported avatar 100 to thereby view a moving image in which the avatar 100 is mainly displayed. Furthermore, switching between the cameras 101 while viewing a moving image of collaboration delivery allows viewing moving images observed from different angles, providing new ways to enjoy moving images to the viewing user 112.

The image taken with the camera 101 as the camera-coordinate origin point is not limited to a rendered image but may be defined as a matrix in which the coordinates, the posture, and the angle of view are recorded. Not all the cameras 101 capture images at the same time. For example, by switching between the plurality of cameras 101, only the posture, coordinates, and conditions of cameras 101 necessary for the scenes of the moment may be transmitted to the viewing user device 12B or the like via the server 11. Using spherical linear interpolation (Slerp) to switch between the plurality of cameras 101 allows animation expression that interpolates multiple states in time. The rendered images may be subjected to synthesis processing, such as blending or blurring, at switching.

Gift Objects in Collaboration Delivery

Next, gift objects in collaboration delivery will be described. An example of the gift objects is an object provided from the viewing user 112 to the delivering user. The server 11 receives a request to display gift objects from the viewing user device 12B. The gift objects include a wearable gift object to be attached to the avatar 100 and a normal gift object not to be attached to the avatar 100.

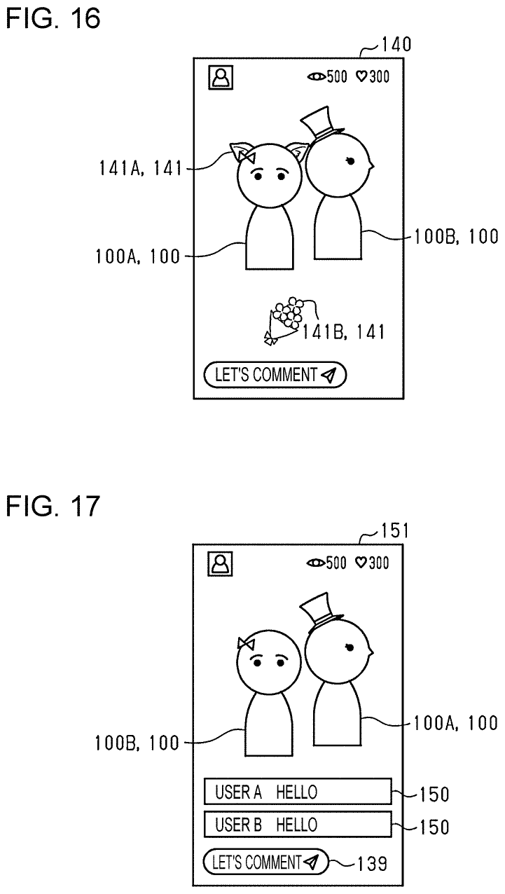

FIG. 16 illustrates a viewing screen 140 displayed on the viewing user device 12B. When a gift-object display request is transmitted from the viewing user device 12B, a gift object 141 is displayed on the viewing screen 140. A wearable gift object 141A is displayed attached to one of the avatars 100, and a normal gift object 141B is displayed at a predetermined position in the virtual space without being attached to the avatar 100. The wearable gift object 141A shown in FIG. 16 is “cat ears” attached to the head of the avatar 100, and the normal gift object 141B is “bouquet”.

In collaboration delivery, the wearable gift object 141A is attached to the avatar 100 selected by the host user. When the viewing user 112 requests to display the wearable gift object 141A, a selection button for selecting the avatar 100A or 100B is displayed on the display 28 of the delivering user device 12A that the host user uses. When the host user selects the avatar 100 by operating the selection button using the controller 27 or the like, the wearable gift object 141A is applied to the selected avatar 100.

When the gift objects 141 are gifted, the sum of prices associated with the gift objects 141 is shared equally by the host user and the guest users who participate in the collaboration delivery. The server 11 adds up the prices associated with the gift objects for each collaboration delivery. The prices are media available in the application, such as “point”, “coin”, or media available outside the application. The server 11 equally divides the prices added up at a predetermined timing, such as when deliver of the moving image is completed, and transmits data indicating the equally divided price to the delivering user device 12A and stores the data in the user management data 350.

Message in Collaboration Delivery

Next, a method for displaying a message in collaboration delivery will be described. The viewing user 112 can transmit a message to the delivering user 110 during delivering a moving image.

As shown in FIG. 17, the viewing screen 151 has a message entry field 139. When the viewing user 112 who is viewing the moving image enters a message in the message entry field 139 and performs an operation for transmitting the entered message, the viewing user device 12B transmits the message to the server 11 together with identification information on the viewing user 112. The server 11 receives the message from the viewing user device 12B and transmits the identification information on the viewing user 112 and the message to all the delivering user devices 12A participating in the collaboration delivery and all the viewing user devices 12B viewing the collaboration delivery.

The viewing screen 151 of the viewing user device 12B displays messages 150 together with the identification information on the viewing user 112. This allows the messages 150 to be shared by the viewing users 112 who are viewing the moving image in the same collaboration delivery. The delivering user device 12A displays the messages 150 at predetermined positions in the virtual space image that the delivering user 110 views. This allows the delivering user 110 to see the messages 150 transmitted from the viewing user 112.

Method of Delivering Moving Image

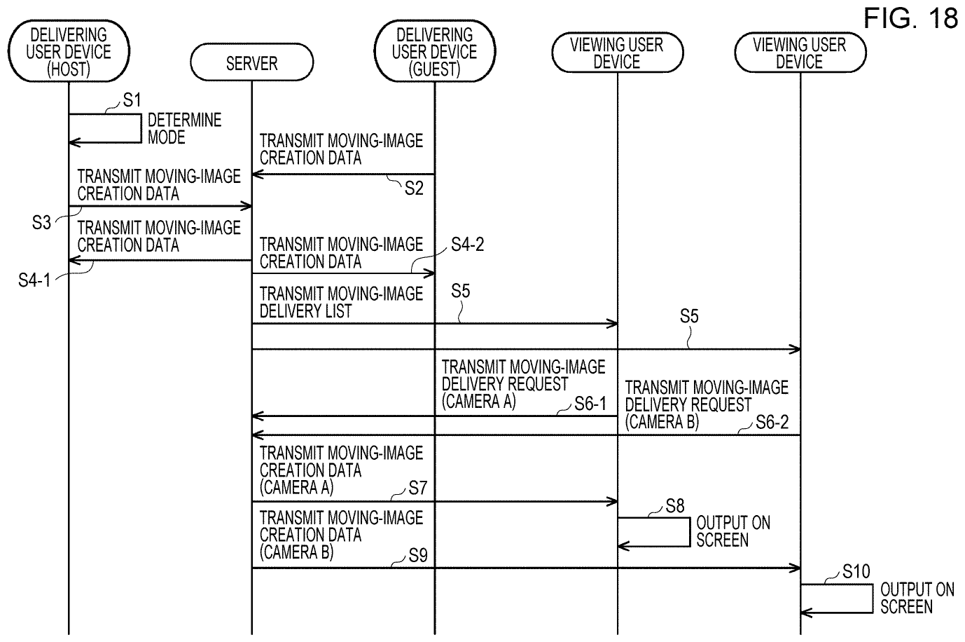

Referring to FIG. 18, a procedure for processing will be described. The delivering user device 12A of the host user receives an operation performed by the host user and determines the mode (step S1). The delivering user device 12A of the delivering user 110 who desires to participate in the collaboration delivery transmits a participation request to the delivering user device 12A of the host user via the server 11. The delivering user device 12A of the guest user is permitted to participate by the delivering user device 12A of the host user.

The delivering user device 12A of the guest user transmits moving-image creation data, which is necessary for creating a moving image, to the server 11 (step S2). Depending on the moving-image delivery scheme, for a client rendering scheme, the moving-image creation data contains at least tracking data containing the detected motion of the guest user, line-of-sight data indicating the position of the pupils 102 of the avatar 100, and voice data. The moving-image creation data may contain camera attribute information on the camera 101 set for the avatar 100 corresponding to the guest user. The camera attribute information contains, for example, positional information and field-of-view information.

Likewise, the delivering user device 12A of the host user transmits moving-image creation data on the delivering user device 12A itself to the server 11 (step S3). The server 11 transmits the moving-image creation data transmitted from the delivering user device 12A of the guest user to the delivering user device 12A of the host user (step S4-1). The server 11 also transmits the moving-image creation data transmitted from the delivering user device 12A of the host user to the delivering user device 12A of the guest user (step S4-2). Upon receiving the moving-image creation data, each of the delivering user devices 12A creates a moving image on the basis of the moving-image creation data and outputs the moving image to the display 28 and the speaker 25. Step S2 to steps S4-1 and S4-2 are repeatedly performed during delivery of the moving images.

The server 11 transmits a moving-image delivery list to the viewing user device 12B at the timing when the viewing user device 12B requests the list (step S5). The timing when the viewing user device 12B requests the list may be before delivery of the moving image or during delivery of the moving image. The moving-image delivery list is a list of moving images being delivered. When the viewing user 112 selects a desired moving image, the viewing user device 12B transmits a request to view the moving image together with information for identifying the selected moving image (step S6-1 and step S6-2). For example, one viewing user device 12B transmits a request to view moving-image creation data taken by “camera A” in collaboration delivery in which “avatar A” and “avatar B” act together (step S6-1). Another viewing user device 12B transmits a request to view moving-image creation data taken by “camera B” in collaboration delivery in which “avatar A” and “avatar B” act together (step S6-2). The viewing user 112 may select the camera 101 by selecting “avatar A” or “avatar B” or by selecting one from the positions of the presented cameras 101, as described above.

The server 11 transmits moving-image creation data taken by “camera A” to the viewing user device 12B that has transmitted a request to view a moving image taken by “camera A” (step S7). The viewing user device 12B receives the moving-image creation data containing line-of-sight data and tracking data according to “camera A”, creates moving-image data viewed from “camera A”, and outputs the moving-image data to the display 48 and the speaker 45 that the viewing user 112 looks at and listens to (step S8). The server 11 transmits moving-image creation data taken by “camera B” to the viewing user device 12B that has transmitted a request to view a moving image taken by “camera B”. The viewing user device 12B creates moving-image data using the received moving-image creation data and outputs the moving-image data to the display 48 (step S10).

(1) The host user who is the delivering user 110 can specify one of the three modes in which the lines of sight of the avatars 100 are directed to different objects. This allows the host user to specify a mode that matches the theme and story of the moving image that the host user delivers and to deliver the moving image in that mode. This allows the delivering user 110 to perform various expressions via the avatars 100, further increasing the satisfaction of the delivering user 110 and the viewing user 112.

(2) In the first mode, a moving image in which the plurality of avatars 100 direct their lines of sight to the corresponding cameras 101 can be delivered in collaboration delivery. This allows the viewing user 112 to select a favorite avatar 100 or a camera 101 corresponding to the avatar 100 and to view a moving image centered on the avatar 100. Thus, the delivering user 110 can deliver a moving image targeted at fans of the delivering user 110 even in collaboration delivery. In addition, the viewing user 112 can view a moving image centered on the favorite avatar 100 while watching interaction of the favorite avatar 100 with another avatar 100.

(3) In the second mode, a moving image in which the plurality of avatars 100 direct their lines of sight to one another can be delivered. This allows for expressing a state in which only the avatars 100A and 100B talk naturally to one another. This expands the range of expression of the delivering user 110, thus increasing the satisfaction of the delivering user 110 and the satisfaction of the viewing user 112 who views the moving image.

(4) In the third mode, a moving image in which the plurality of avatars 100 direct their lines of sight to the common camera 101 can be delivered. This allows capturing a specific scene, such as a ceremonial photograph.

(5) The cameras 101 are set in the camera range 109 centered on the center point 108 set according to the positions of the plurality of avatars 100. This allows the cameras 101 to be disposed so that all of the avatars 100 who perform collaboration delivery are included in the viewing angle FV as much as possible.

(6) Since the plurality of cameras 101 are set in the camera range 109, the plurality of avatars 100 can be photographed from different angles at the same time.

(7) If the cameras 101 can be moved according to an operation of the delivering user 110 on the controller 27, the range of expression of the delivering user 110 can be further increased.

(8) The image processing unit 202 calculates the angle formed by the vector from each camera 101 to each avatar 100 and the optical axis Ax of the camera 101 to determine an avatar 100 whose absolute value of the angle is the greatest. The image processing unit 202 sets the viewing angle FV so that the avatar 100 whose absolute value of the angle is the greatest is included. This allows for setting a viewing angle FV in which all of the avatars 100 are included even if the avatars 100 move around in the virtual space in response to the motions of the delivering users 110.

System Configuration

In the above embodiments, the viewing user device 12B allows the viewing user 112 to view a moving image using the moving image program 420, which is a native application program installed in the storage 42. In place of or in addition to this, in a case or situation in which there is no need for the viewing user device 12B to perform rendering, the moving image may be displayed using a web application for displaying a web page written in a markup language, such as Hyper Text Markup Language (HTML), in a browser. Alternatively, the moving image may be displayed using a hybrid application having a native application function and a web application function. The moving image program 220 stored in the delivering user device 12A may be the same as or different from the moving image program 420 stored in the viewing user device 12B.

In the above embodiments, the moving image programs 220 and 420 have both the delivery function and the viewing function. In place of or in addition to this, the management system 10 may include a user device 120 that includes a head-mounted display and that implements only one of the delivery function and the viewing function. The management system 10 may include a user device 121 that includes no head-mounted display and that implements only one of the delivery function and the viewing function. In this case, the user device 120 that includes a head-mounted display having at least the delivery function delivers a moving image in which one of the first mode, the second mode, and the third mode is set, and the user devices 120 and 121 having at least the viewing function view the moving image.

Method of Delivering Moving Image

In the collaboration delivery of the above embodiments, the delivering user device 12A of a delivering user transmits a collaboration delivery request to the delivering user device 12A of the host user. The request is approved by the delivering user to enable the joint appearance. In place of or in addition to this, the collaboration delivery may be performed with another procedure. For example, in the case where a plurality of delivering users 110 who perform collaboration delivery is present in a delivery studio, or in the case where they have logged in a predetermined website of which they are notified in advance, the collaboration delivery may be performed without setting host and guest users. If no host user is set, the delivering users 110 or an operator present in the delivery studio may select the mode.

In the above embodiments, the client rendering scheme is described as the moving-image delivery scheme. In place of this, the first delivery scheme may be used as the moving-image delivery scheme. For collaboration delivery in this scheme, the delivering user device 12A obtains a mode related to the lines of sight of the avatars 100 according to the operation performed by the delivering user 110 or the like. The delivering user device 12A receives moving-image creation data from the delivering user device 12A of another delivering user 110 participating in the collaboration delivery. The delivering user device 12A creates an animation of the avatars 100 to which the moving-image creation data is applied and performs rendering in combination with another object to create moving-image data. The delivering user device 12A encodes the moving-image data and transmits the moving-image data to the viewing user device 12B via the server 11. If the camera 101 is set for each avatar 100, the delivering user device 12A sets the camera 101 for each delivering user device 12A and creates moving images viewed from the individual cameras 101. The configuration of the moving-image display data depends on the moving-image delivery scheme.

In the above embodiments, the control unit 20 of the user device 12 or the control unit 40 of the user device 12 functions as the mode acquisition unit, the moving-image creating unit, and the moving-image-data transmitting unit. The mode acquisition unit, the moving-image creating unit, and the moving-image-data transmitting unit are changed depending on the moving-image delivery scheme. The mode acquisition unit, the moving-image creating unit, and the moving-image-data transmitting unit may be disposed in a single device or may be distributed among a plurality of devices. If the server 11 creates moving-image data, the server 11 functions as the mode acquisition unit, the moving-image creating unit, and the moving-image-data transmitting unit. If the viewing user device 12B creates moving-image data, the viewing user device 12B functions as the mode acquisition unit, the moving-image creating unit, and the moving-image-data transmitting unit. Alternatively, for example, the mode acquisition unit, the moving-image creating unit, and the moving-image-data transmitting unit may be distributed among the delivering user device 12A and the server 11. In other words, at least one of the server 11 and the viewing user device 12B may implement some of the functions of the delivering user device 12A of the embodiments. Alternatively, at least one of delivering user device 12A and the viewing user device 12B may implement some of the functions of the server 11 of the embodiments. Alternatively, at least one of the server 11 and the delivering user device 12A may implement some of the functions of the viewing user device 12B. In other words, the processes performed by the delivering user device 12A, the viewing user device 12B, and the server 11 of the embodiments may be performed by any of the devices depending on the video delivery scheme and the type of device, or may be performed by devices other than the delivering user device 12A, the viewing user device 12B, and the server 11.

In the above embodiments, the delivering user device 12A that delivers a moving image to which one of the first mode, the second mode, and the third mode is applied is the user device 120 including a head-mounted display. In place of this, the delivering user device 12A that delivers a moving image to which one of the first mode, the second mode, and the third mode is applied may be the user device 121 with no head-mounted display, rather than the user device 120 including a head-mounted display. In this embodiment, the orientation and position of the avatar 100 may be changed not only depending on at least one of the orientations of the head and the upper body of the user, but also according to an operation of the user on the touch panel display or the controller. In this embodiment, an image of a virtual space viewed from the avatar 100 or an image of a virtual space viewed from the camera set in any of the first mode, the second mode, and the third mode may be output on the display 48 of the user device 121. In the latter case, the preview screen 122 may be omitted.

Modes

In the above embodiments, the second mode is a mode in which the avatars 100 who act together direct their lines of sight to each other. However, if there are a plurality of other avatars 100 in the vicinity of the avatar 100, the behavior of the pupils 102 may be controlled using one of the following methods (A) to (C).

(A) The pupils 102 are made to follow the center of the other avatars 100.

(B) The pupils 102 of the avatar 100 are made to follow a specific part of one of the other avatars 100 for a predetermined time and then follow a specific part of another avatar 100, thereby directing the line of sight to the other avatars 100 in sequence.

(C) The pupils 102 are made to follow a point at which the lines of sight of the other avatars 100 intersect.

Alternatively, some of the methods (A) to (C) may be combined. Combining a plurality of methods allows making the expressions of the avatars 100 realistic. In addition to the methods (A) to (C), a predefined parameter indicating favor to a specific user or camera or a weighting for control may be added. In addition to the first to third modes, a mode including one of the methods (A) to (C) may be selectable.

In the above embodiments, the line of sight of each avatar 100 is directed to the corresponding camera 101 or another facing avatar 100. In place of or in addition to this, the line of sight of the avatar 100 may be directed to a specific object other than the camera 101 and the avatars 100. For example, the line of sight may be set to a moving object moving in the virtual space. Examples of the moving object include a ball and a non-player character (NPC). In this case, the pupils 102 are moved in a predetermined range so that the motion of the pupils 102 of the avatar 100 follows the motion of the specific object.

In the above embodiments, the host user selects one of the first mode, the second mode, and the third mode. The host user need only be capable of selecting one of the plurality of modes. In place of this, the host user may be capable of selecting the first mode or the second mode. Alternatively, the hose user may be capable of selecting the first mode or the third mode, or the second mode or the third mode. Alternatively, the guest user may be capable of selecting one of the plurality of modes.

In the above embodiments, the delivering user 110 provides an instruction to switch among the first mode, the second mode, and the third mode. In place of or in addition to this, the delivering user device 12A or the server 11 may automatically switch among the first mode, the second mode, and the third mode. Specifically, the delivering user device 12A or the server 11 may switch the mode to the third mode when the delivering user 110 performs an operation to request to start a predetermined scene, such as an operation on a start button using the controller 27 or the like in the first mode or the second mode. Alternatively, the delivering user device 12A or the server 11 may switch the mode to the third mode when a start condition, such as generation of a predetermined animation or voice, is satisfied during delivery. Alternatively, the delivering user device 12A or the server 11 may switch the mode to the third mode when the coordinates of the avatars 100 satisfy a start condition, for example, when the avatars 100 have gathered to a predetermined area. Alternatively, when the delivering user has recognized a speech and spoken a predetermined keyword or the like, the mode may be switched to a mode associated with the keyword. For example, when the delivering user 110 has spoken the word “look at each other”, the mode may be switched to the second mode.

In the above embodiments, another mode may be selected in place of or in addition to one of the first mode, the second mode, and the third mode. An example of the mode other than the three modes is a mode in which the plurality of avatars 100 are photographed by a camera 101 that looks down them, and the avatars 100 face in a direction other than the direction toward the camera 101, such as the front direction.

In the above embodiments, the image processing unit 202 of the delivering user device 12A creates line-of-sight data for directing the lines of sight of the avatars 100 to the cameras 101 or another avatar 100. In place of this, the viewing user device 12B may create an animation in which the pupils 102 of each avatar 100 are directed to the target of the line of sight on the basis of tracking data indicating the position and orientation of the avatar 100 and position data on the target of the line of sight, such as the camera 101, the other object, or another avatar 100.

Selecting Camera

In the above embodiments, the viewing user 112 selects an avatar 100 participating in collaboration delivery on the screen of the viewing user device 12B to display a moving image taken by the camera 101 corresponding to the selected avatar 100 on the viewing user device 12B. In place of this, the viewing user 112 may select one of the plurality of cameras 101 set for collaboration delivery on the screen of the viewing user device 12B so that a moving image taken by the selected camera 101 is displayed on the viewing user device 12B. On the camera selection screen, the camera 101 may be selected from the position “above”, “below”, “left”, or “right” with respect to the avatar 100, or may be selected at an angle, such as “bird's eye view” or “worm's eye view”.

In the above embodiments, the viewing user 112 selects the avatar 100 or the camera 101 when viewing the collaboration delivery. However, if one of the plurality of modes has been specified, the selection of the avatar 100 or the camera 101 may be omitted. In other words, a moving image taken by the camera 101 determined by the server 11 may be delivered in collaboration delivery. At that time, the server 11 may switch among the cameras 101 at a predetermined timing.

Position and Field of View of Camera

In the above embodiments, the camera 101 is set in the spherical camera range 109. In place of or in addition to this, a camera only the elevation angle and the azimuth angle of which can be controlled, with the coordinates of the rotation center fixed, may be set as a model installed on a virtual tripod in a virtual space or a real space. The camera may be “panned” so that the optical axis is moved sideways with the rotation center coordinates fixed. The camera may be panned in response to an operation of the delivering user 110 on the controller 27 or the occurrence of a predetermined event, and the angle of field may be smoothly changed by moving the optical axis horizontally while gazing at the target object. The camera may be “tilted” so as to move the optical axis vertically.

In the above embodiments, when the relative distance between the avatars 100 is large, the image processing unit 202 increases the distance R of the camera range 109 and the viewing angle FV. When the relative distance between the avatars 100 is small, the image processing unit 202 decreases the distance R of the camera range 109 and reduces the viewing angle FV. In place of this, the image processing unit 202 may change only the distance R of the camera range 109, with the viewing angle FV fixed, depending on the relative distance between the avatars 100. Alternatively, the image processing unit 202 may change only the viewing angle FV, with the distance R of the camera range 109 fixed, depending on the relative distance between the avatars 100.

In the above embodiments, the camera range 109 is centered on the center point 108 of the avatars 100, and the cameras 101 are set in the camera range 109. In place of or in addition to this, the cameras 101 may be fixed to predetermined positions in the virtual space.

In the above embodiments, the viewing angle FV is set so as to include an avatar 100 farthest from the cameras 101. In place of or in addition to this, the viewing angle FV may be fixed in a fixed range.

In the above embodiments, the delivering user device 12A including a non-transmissive head-mounted display displays a virtual reality image, and the viewing user device 12B displays a virtual space image. In place of this, the transmissive head-mounted display may display an augmented reality image. In this case, the camera 101 is positioned at the image capturing camera provided at the delivering user device 12A, and the position changes depending on the position of the delivering user 110. In this case, the delivering user device 12A creates moving-image data in which a virtual space image is superposed on a reality image captured by the image capturing camera. The delivering user device 12A encodes the moving-image data and transmits the moving-image data in encoded form to the viewing user device 12B via the server 11.

Gift Object and Price

In the above embodiments, a wearable object is applied to an avatar selected by the host user. In place of or in addition to this, a wearable object may be applied to an avatar associated with a moving image being viewed. This method is applicable in the case of the first mode or the second mode and in which the avatars 100 and the cameras 101 are associated with each other. Assuming that an operation for executing a request to display a wearable gift object 141A is given from the viewing user device 12B that displays a moving image captured by a camera 101 corresponding to “avatar A”, the server 11 determines to apply the wearable gift object 141A to “avatar A”. The server 11 transmits the request to display the wearable gift object 141A to the delivering user device 12A that renders “avatar A”. The request to display the wearable gift object 141A is transmitted to the delivering user device 12A of the host user. The delivering user device 12A creates a moving image in which the wearable gift object 141A is attached to “avatar A”.

In the above embodiments, the sum of the prices associated with the gift objects is equally shared by the host user and the guest users who participate in the collaboration delivery. In place of or in addition to this, the viewing user 112 who gives the gift object 141 may apply a price according to the gift object 141 to the delivering user 110 corresponding to the moving image being viewed. This method is applicable to the case of the first mode or the second mode and in which the avatars 100 and the cameras 101 are associated with each other. Assuming that the viewing user device 12B has received an operation for giving a request to display the wearable gift object 141A when the viewing user device 12B is displaying a moving image captured by the camera 101 corresponding to “avatar A”, the server 11 applies the price to the delivering user 110 corresponding to “avatar A”. Specifically, the server 11 updates data indicating the price of the user management data 350 of the delivering user 110 corresponding to “avatar A”. The server 11 transmits a notification that the price has been given to the delivering user device 12A.

Message in Collaboration Delivery

In the above embodiments, a message transmitted from the viewing user 112 is transmitted to all the delivering user devices 12A participating in the collaboration delivery and all the viewing user devices 12B viewing the collaboration delivery. In place of or in addition to this, the message transmitted by the viewing user device 12B may be displayed only in a moving image delivered to the viewing user device 12B. In this method, when the viewing user device 12B displays a moving image captured by the camera 101 corresponding to “avatar A”, the message transmitted by the viewing user device 12B is displayed only on the viewing user device 12B that displays the moving image captured by the camera 101 associated with the same “avatar A”, and is not displayed on the viewing user device 12B that displays a moving image captured by the camera 101 associated with “avatar B”. The number of messages to be displayed on one screen can be reduced.

Embodiment Other than Collaboration Delivery

In the above embodiments, a plurality of modes in which the targets of the lines of sight of the avatars 100 differ is set for collaboration delivery. In place of this, these modes may be selectable when the delivering user 110 solely delivers a moving image. In this case, for example, a plurality of modes can be set among a mode in which the avatar 100 directs the line of sight to the camera 101, a mode in which the avatar 100 directs the line of sight to an object other than the camera 101 or a predetermined position, and a mode in which the avatar 100 always looks to the front and does not move the pupils 102.

Next, a technical idea that can be ascertained from the above embodiments and other examples will be added as follows.

A program configured to cause one or a plurality of computers to function as:

a mode acquisition unit that acquires one of a plurality of modes related to a line of sight of an avatar corresponding to a motion of a delivering user who wears a non-transmissive or transmissive head-mounted display, the modes being such that the line of sight is directed to different objects;

a data acquisition unit that acquires moving-image creation data for creating a moving image;

a moving-image creating unit that creates, according to a specified one of the modes, moving-image data on a virtual space taken by a virtual camera in which the avatar is disposed using the moving-image creation data; and

an output control unit that outputs the created the moving-image data on a display.

What is claimed is:

1. A non-transitory computer readable medium storing computer executable instructions which, when executed by one or more computers, cause the one or more computers to:
acquire a mode of a plurality of modes in which each mode corresponding to a line of sight directed to a different object of plural objects, the mode related to a line of sight of an avatar corresponding to a motion of a delivering user wearing a head-mounted display;
create, according to the mode, moving-image display data for displaying a moving image of a virtual space in which the avatar is disposed as viewed from a virtual camera; and
transmit the moving-image display data to a viewing user device for display to a viewing user.

2. The non-transitory computer readable medium according to claim 1, wherein
according to the mode, lines of sight of avatars are directed to virtual cameras, and
the moving-image display data is created to include line-of-sight data for directing the lines of sight of the avatars to the virtual cameras, the virtual cameras being set at different positions for the individual avatars.

3. The non-transitory computer readable medium according to claim 1, wherein
according to the mode, when each of a plurality of delivering users each wearing a head-mounted display delivers a moving image, lines of sight of avatars are directed to another avatar, and
the moving-image display data is created to include animations of the plurality of avatars and line-of-sight data for directing the line of sight of each of the avatars to another avatar different from the avatar.

4. The non-transitory computer readable medium according to claim 1, wherein
according to the mode, when each of a plurality of delivering users each wearing a head-mounted display delivers a moving image, lines of sight of avatars are directed to a common virtual camera, and
the moving-image display data is created to include animations of the plurality of avatars and line-of-sight data for directing the lines of sight of the avatars to the common virtual camera.

5. The non-transitory computer readable medium according to claim 1, wherein the one or more computers are further caused to:
when creating animations of avatars corresponding to a plurality of delivering users, set a camera range centered on a center point set based on positions of a plurality of avatars, and set the virtual camera at any position in the camera range.

6. The non-transitory computer readable medium according to claim 5, wherein a plurality of virtual cameras are set in the camera range.

7. The non-transitory computer readable medium according to claim 5, wherein the virtual camera is moved within the camera range according to operations of the delivering users on operating units.

8. The non-transitory computer readable medium according to claim 1, wherein the one or more computers are further caused to:
when creating animations of avatars corresponding to a plurality of delivering users, determine an avatar whose absolute value of an angle formed by a vector directed from the virtual camera to the avatar and an optical axis of the virtual camera is greatest, and specify a viewing angle of the virtual camera so as to include the avatar therein.

9. The non-transitory computer readable medium according to claim 1, wherein
the head-mounted display is a transmissive head-mounted display,
the virtual camera is positioned at a position of an image capturing camera that is movable in a real space by the delivering user, and
the moving-image display data is created such that display of a moving image, in which the image of the virtual space as viewed from the virtual camera, is superposed on an image of the real space captured by the image capturing camera.

10. The non-transitory computer readable medium according to claim 1, wherein the moving-image display data is transmitted in encoded form to the viewing user device.

11. An information processing method executed by one or more computers, the information processing method comprising:
acquiring a mode of a plurality of modes in which each mode corresponding to a line of sight directed to a different object of plural objects, the mode related to a line of sight of an avatar corresponding to a motion of a delivering user wearing a head-mounted display;
creating, according to the mode, moving-image display data for displaying a moving image of a virtual space in which the avatar is disposed as viewed from a virtual camera; and
transmitting the moving-image display data to a viewing user device for display to a viewing user.

12. The information processing method according to claim 11, wherein
according to the mode, lines of sight of avatars are directed to virtual cameras, and
the moving-image display data is created to include line-of-sight data for directing the lines of sight of the avatars to the virtual cameras, the virtual cameras being set at different positions for the individual avatars.

13. The information processing method according to claim 11, wherein
according to the mode, when each of a plurality of delivering users each wearing a head-mounted display delivers a moving image, lines of sight of avatars are directed to another avatar, and
the moving-image display data is created to include animations of the plurality of avatars and line-of-sight data for directing the line of sight of each of the avatars to another avatar different from the avatar.

14. The information processing method according to claim 11, wherein
according to the mode, when each of a plurality of delivering users each wearing a head-mounted display delivers a moving image, lines of sight of avatars are directed to a common virtual camera, and
the moving-image display data is created to include animations of the plurality of avatars and line-of-sight data for directing the lines of sight of the avatars to the common virtual camera.

15. The information processing method according to claim 11, further comprising:
when creating animations of avatars corresponding to a plurality of delivering users, setting a camera range centered on a center point set based on positions of a plurality of avatars, and setting the virtual camera at any position in the camera range.

16. The information processing method according to claim 15, wherein a plurality of virtual cameras are set in the camera range.

17. The information processing method according to claim 15, wherein the virtual camera is moved within the camera range according to operations of the delivering users on operating units.

18. The information processing method according to claim 11, further comprising:
when creating animations of avatars corresponding to a plurality of delivering users, determining an avatar whose absolute value of an angle formed by a vector directed from the virtual camera to the avatar and an optical axis of the virtual camera is greatest, and specifying a viewing angle of the virtual camera so as to include the avatar therein.

19. The information processing method according to claim 11, wherein
the head-mounted display is a transmissive head-mounted display,
the virtual camera is positioned at a position of an image capturing camera that is movable in a real space by the delivering user, and
the moving-image display data is created such that display of a moving image, in which the image of the virtual space as viewed from the virtual camera, is superposed on an image of the real space captured by the image capturing camera.

20. A non-transitory computer readable medium storing computer executable instructions which, when executed by one or more computers, cause the one or more computers to:
receive, from a server, line-of-sight data corresponding to a mode of a plurality of modes, each mode of the plurality of modes corresponding to a line of sight directed to a different object of plural objects, wherein the line-of-sight data is related to a line of sight of an avatar corresponding to a motion of a delivering user wearing a head-mounted display;
receive, from the server, tracking data indicating the motion of the delivering user;
create, using the tracking data and the line-of-sight data, moving-image data for displaying a moving image of a virtual space in which the avatar is disposed as viewed from a virtual camera; and
output the moving-image data to a display for display to a viewing user.
